(19) United States
(12) Patent Application Publication
(10) Pub. No.: US 2012/0274134 A1
(43) Pub. Date: Nov. 1, 2012

(54) DC-DC CONVERTER, METHOD FOR OPERATING THE DC-DC CONVERTER, ENVIRONMENTAL ENERGY HARVESTING SYSTEM COMPRISING THE DC-DC CONVERTER, AND APPARATUS COMPRISING THE ENERGY HARVESTING SYSTEM

(75) Inventors: Alessandro Gasparini, Cusano Milanino (IT); Stefano Ramorini, Arluno (IT); Giorgio Massimiliano Membretti, Milano (IT)

(73) Assignee: STMICROELECTRONICS S.R.L., Agrate Brianza (MB) (IT)

(21) Appl. No.: 13/456,545

(22) Filed: Apr. 26, 2012

(30) Foreign Application Priority Data
Apr. 29, 2011 (IT) TO2011A000376

(51) Int. Cl. H02J 1/00

(52) U.S. Cl. 307/31

(57) ABSTRACT

A DC-DC converter independently supplies electrical loads. The converter includes a charge switch and a discharge switch connected between an input supply and a reference. An inductor has a first terminal connected between the charge switch and the discharge switch and a second terminal. Coupling switches are provided between the inductor second terminal and the electrical loads. An adaptive-control circuit acquires, during supply of each electrical load, a signal indicating the voltage value across the inductor and generates a first time interval as a function of the signal indicating the voltage value detected. Each electrical load is supplied during the first time interval, and completely discharged during a second time interval subsequent to the first time interval.

### PRIORITY CLAIM

This application claims priority from Italian Application for Patent No. TO2011A00376 filed Apr. 29, 2011, the disclosure of which is hereby incorporated by reference.

### TECHNICAL FIELD

The present invention relates to a DC-DC converter, in particular of a single-inductor multiple-output (SIMO) type. The present invention moreover relates to an environmental energy harvesting system comprising the DC-DC converter, and to an apparatus comprising said environmental energy harvesting system.

### BACKGROUND

As is known, systems for harvesting energy (also known as “energy harvesting systems” or “energy-scavenging systems”) from intermittent environmental energy sources (i.e., sources that supply energy in an irregular way) have aroused and continue to arouse considerable interest in a wide range of technological fields. Typically, energy harvesting systems are designed to harvest, store, and transfer energy generated by mechanical sources to a generic load of an electrical type.

Low-frequency vibrations, such as for example mechanical vibrations of disturbance in systems with moving parts can be a valid source of energy. The mechanical energy is converted, by one or more appropriate transducers (for example, piezoelectric or electromagnetic devices) into electrical energy, which can be used for supplying an electrical load. In this way, the electrical load does not require batteries or other supply systems that are cumbersome and poorly resistant to mechanical stresses.

FIG. 1 is a schematic illustration, by means of functional blocks, of an energy harvesting system of a known type.

The energy harvesting system 1 of FIG. 1 comprises: a transducer 2, for example of an electromagnetic or piezoelectric type, subject during use to environmental mechanical vibrations and configured for converting mechanical energy into electrical energy, typically into AC (alternating current) voltages; a scavenging interface 4, for example comprising a diode-bridge rectifier circuit (also known as Graetz bridge), configured for receiving at input the AC signal generated by the transducer 2 and supplying at output a DC (direct current) signal for charging a capacitor 5 connected to the output of the rectifier circuit 4; and a DC-DC converter 6, connected to the capacitor 5 for receiving at input the electrical energy stored by the capacitor 5 and supplying it to an electrical load 8. The capacitor 5 hence has the function of energy-storage element, energy which is made available, when required, to the electrical load 8 for operation of the latter.

The transducer 2 is, for example, an electrochemical transducer, or an electromechanical transducer, or an electroacoustic transducer, or an electromagnetic transducer, or a photoelectric transducer, or an electrostatic transducer, or a thermoelectrical transducer.

The global efficiency η_{TOT} of the energy harvesting system 1 is given by Eq. (1) below

η_{TOT}=η_{TRANSD}·η_{SCAV}·η_{DCDC} (1)

wherein η_{TRANSD} is the efficiency of the transducer 2, indicating the amount of energy available in the environment that has been effectively converted, by the transducer 2, into electrical energy; η_{SCAV} is the efficiency of the scavenging interface 4, indicating the energy consumed by the scavenging interface 4 and the factor of impedance decoupling between the transducer and the interface; and η_{DCDC} is the efficiency of the DC-DC converter 6.

As is known, in order to supply to the load the maximum power available, the impedance of the load should be equal to that of the source. The transducer 2 can be represented schematically, in this context, as a voltage generator provided with an internal resistance R_{S} of its own. The maximum power P_{TRANSD}^{MAX} that the transducer 2 can supply at output may be defined as:

P_{TRANSD}^{MAX}=V_{TRANSD}_{_{—}}_{EQ}²/4R_{S} if R_{LOAD}=R_{S} (2)

wherein V_{TRANSD}_{_{—}}_{EQ} is the voltage produced by the equivalent voltage generator; and R_{LOAD} is the equivalent electrical resistance at the output of the transducer 2 (or, likewise, seen at input to the scavenging interface 4), which takes into due consideration the equivalent resistance of the scavenging interface 4, of the DC-DC converter 6, and of the load 8.

On account of the impedance decoupling (R_{LOAD}≠R_{S}), the power at input to the scavenging interface 4 is lower than the maximum power available P_{TRANSD}^{MAX}.

The power P_{SCAV} stored by the capacitor 5 is a fraction of the power recovered by the interface, and is given by Eq. (3) below

P_{SCAV}=η_{TRANSD}·η_{SCAV}·P_{TRANSD}^{MAX} (3)

whilst the power P_{EL}_{_{—}}_{LOAD} supplied at output by the DC-DC converter to the electrical load 8 is given by the following Eq. (4)

P_{EL}_{_{—}}_{LOAD}=P_{DCDC}·η_{DCDC} (4)

where P_{DCDC} is the power received at input by the DC-DC converter 8, in this case coinciding with P_{SCAV}.

The main disadvantage of the configuration according to FIG. 1 regards the fact that the maximum voltage supplied at output from the scavenging interface 4 is limited by the input dynamics of the DC-DC converter 8.

The voltage V_{OUT} across the capacitor 5 (supplied at output from the scavenging interface 4 and at input to the DC-DC converter 8) is in fact determined on the basis of the balancing of power according to the following Eq. (5)

P_{STORE}=P_{SCAV}−P_{DCDC} (5)

In applications where the transducer 2 converts mechanical energy into electrical energy in a discontinuous way (i.e., the power P_{TRANSD}^{MAX} varies significantly in time) and/or the power P_{EL}_{_{—}}_{LOAD} required by the electrical load 8 varies significantly in time, also the voltage V_{OUT} consequently presents a plot that is variable in time.

This causes, for example, a variation of the efficiency factor η_{DCDC}, which assumes low values at high values of V_{OUT}. The maximum value of V_{OUT} is moreover limited by the range of input voltages allowed by the DC-DC converter.

### SUMMARY

The aim of the present invention is to provide a DC-DC converter, a method for operating the DC-DC converter, an energy harvesting system comprising the DC-DC converter, and an apparatus comprising the energy harvesting system that will enable the aforesaid problems and disadvantages to be overcome. In particular, the DC-DC converter according to the present invention enables an efficiency factor η_{DCDC} to be kept high even in conditions of light load, for example of less than 1 mW. Moreover, the dynamics of input voltages is maximized.

Consequently, according to the present invention a DC-DC converter, a method for operating the DC-DC converter, an energy harvesting system comprising the DC-DC converter, and an apparatus comprising the energy harvesting system, are provided as defined in the annexed claims.

### BRIEF DESCRIPTION OF THE DRAWINGS

For a better understanding of the present invention, preferred embodiments thereof are now described, purely by way of non-limiting example and with reference to the attached plates of drawings, wherein:

FIG. 1 shows an energy harvesting system of a known type;

FIG. 2 is a schematic illustration of a DC-DC converter of a single-inductor multiple-output (SIMO) type;

FIG. 3 shows in greater detail the DC-DC converter of FIG. 2;

FIGS. 4a-4c show in schematic form a temporal division for supply of electrical loads by means of the DC-DC converter of FIG. 2 or FIG. 3 according to a time-multiplexing technique;

FIGS. 5a and 5b show by way of example steps of charging and complete discharging of the inductor 18 of the DC-DC converter of FIG. 2 or FIG. 3, according to a discontinuous-conduction mode (DCM);

FIG. 6 shows an embodiment of a driving circuit of a switch designed to couple the inductor of the DC-DC converter of FIG. 2 or FIG. 3 with an input supply signal source;

FIGS. 7a and 7b show control signals of the driving circuit of FIG. 6;

FIG. 7c shows the plot of signals internal to the DC-DC comparator of FIG. 2 or FIG. 3 when it comprises the driving circuit of FIG. 6, using the time scale of the signals of FIGS. 7a and 7b;

FIG. 8 shows a dead-time generator circuit, which can be coupled to the DC-DC converter of FIG. 2 or FIG. 3;

FIG. 9 shows in greater detail a portion of the dead-time generator circuit of FIG. 8;

FIGS. 10a-10c show signals for management and control of the dead-time generator circuit of FIGS. 8 and 9;

FIG. 10d shows the plot of a signal internal to the DC-DC comparator of FIG. 2 or FIG. 3 when it comprises the dead-time generator circuit of FIG. 8, using the time scale of the signals of FIGS. 10a-10c;

FIG. 11 shows an embodiment of the DC-DC converter comprising circuits for driving switches of the DC-DC converter used during steps of discharge of the inductor;

FIG. 12 shows an embodiment of a switch coupled to the inductor of the DC-DC converter of FIG. 11, which can be operated during steps of discharge of the inductor;

FIG. 13 shows an embodiment of the DC-DC converter comprising an adaptive-control circuit configured for managing coupling and decoupling of the inductor to/from a plurality of electrical loads, for supplying the electrical loads;

FIG. 14 shows a circuit designed to co-operate with the adaptive-control circuit of FIG. 13 for generation of a time interval for charging the single inductor of the DC-DC converter according to the present invention;

FIG. 15 shows a circuit including the circuit of FIG. 14 and designed to generate a clock signal;

FIGS. 16a-16b show logic signals internal to the circuit of FIG. 15;

FIG. 17 shows steps of a method for operating the DC-DC converter of FIG. 13;

FIG. 18 shows an environmental energy harvesting system comprising the DC-DC converter of FIG. 13; and

FIG. 19 shows a vehicle comprising the environmental energy harvesting system of FIG. 18.

### DETAILED DESCRIPTION OF THE DRAWINGS

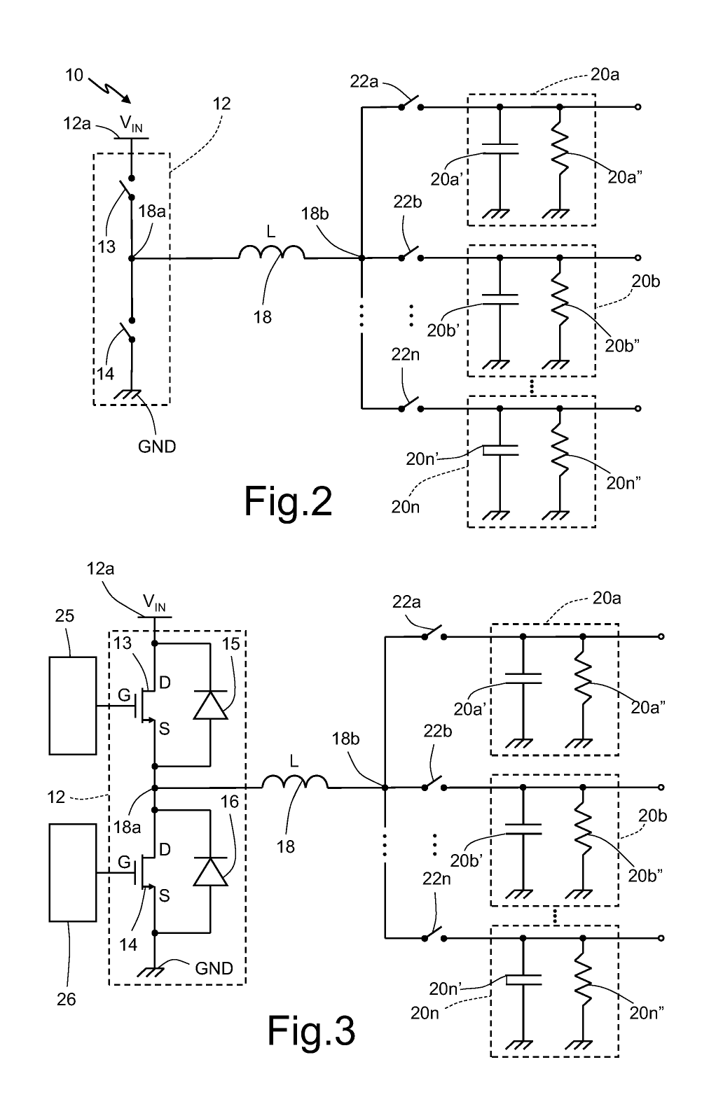

FIG. 2 is a schematic illustration of a DC-DC converter 10, in particular of a buck type, comprising a single inductor 18 coupled to the input of the DC-DC converter 10, and a plurality of outputs for supplying a respective plurality of loads 20a-20n, also known as SIMO (single-inductor multiple-output) converter.

In greater detail, the converter 10 comprises a main bridge 12, including a supply terminal 12a at voltage V_{IN} (with V_{IN} ranging, for example, between 1 V and 40 V) and a reference terminal at ground voltage GND (for example, at approximately 0 V, even though other reference voltages can be used, for example −V_{IN}). The main bridge 12 moreover includes a high-side switch 13 and a low-side switch 14, connected in series to one another between the supply terminal 12a and the reference terminal GND. In particular, the high-side switch 13 is connected directly to the supply terminal 12a for receiving the signal V_{IN}, and the low-side switch 14 is connected directly to the reference terminal GND.

According to one embodiment (see FIG. 3), the high-side switch 13 is a MOSFET, in particular an n-channel double-diffusion MOS (DMOS) transistor with resistance in an ON state (R_{ON}) of approximately 1Ω at 100 mA. The low-side switch 14 is of the same type as the transistor 13. Alternatively, the high-side switch 13 and the low-side switch 14 can be obtained with a different technology; for example, they may be p-channel MOSFETs, or NPN or PNP bipolar transistors, IGBTs, or simply diodes.

With reference to FIG. 3, a diode 15 and a diode 16 are connected between a respective source terminal S and a respective drain terminal D of the high-side switch 13 and of the low-side switch 14. The diodes 15 and 16 are connected in antiparallel configuration (with respect to the normal direction of flow of the current through the high-side switch 13 and the low-side switch 14). As is known, a characteristic of a MOSFET is that of displaying, under certain operating conditions, the electrical properties of a diode (parasitic diode). Said diode is electrically set (integrated) between the source and drain terminals of the MOSFET. In other words, the high-side switch 13 and the low-side switch 14 can present the electrical behavior of a diode, where the cathode of the diode corresponds to the drain terminal and the anode to the source terminal of the respective high-side switch 13 and low-side switch 14 (vice versa, in the case of p-type MOSFETs). In greater detail, the drain terminal D of the high-side switch 13 is connected to the supply terminal 12a, the source terminal S of the high-side switch 13 is connected to the drain terminal of the low-side switch 14, and the source terminal S of the low-side switch 14 is connected to the reference terminal GND. The high-side switch 13 and low-side switch 14 are driven in conduction by means of a respective first driving circuit 25 and second driving circuit 26, which are described more fully hereinafter. The driving circuits 25, 26 are connected to the control terminal or gate terminal G of the transistors that form the high-side switch 13 and low-side switch 14.

With joint reference to FIGS. 2 and 3, the DC-DC converter 10 further comprises an inductor 18, having an inductance L of between approximately 1 pH and approximately 20 pH. The inductor 18 includes a first conduction terminal 18a connected between the high-side switch 13 and the low-side switch 14 (in particular, connected to the source terminal S and drain terminal D of the high-side switch 13 and of the low-side switch 14, respectively), and a second terminal 18b, connected to a plurality of electrical loads 20a, 20b . . . 20n by means of a plurality of respective coupling switches 22a, 22b . . . 22n. Each coupling switch 22a-22n is hence connected in series to the inductor 18.

Each electrical load 20a-20n comprises, for example, a capacitor 20a′-20n′ and a resistor 20a″-20b″ connected between the second terminal 18b of the inductor 18 and the reference terminal GND.

The coupling switches 22a-22n, as shown in FIGS. 2 and 3, have the function of enabling a plurality of mutually independent outputs (the plurality of “n” electrical loads 20a-20n) to share the single inductor 18. To guarantee absence of cross conduction between the electrical loads 20a-20n, the coupling switches 22a-22n are controlled (opened/closed) using a time-multiplexing technique.

Each electrical load 20a-20n can require a supply voltage value Vₒᵤₜ_{_{—}}ₐ, Vₒᵤₜ_{_{—}}_{b} . . . Vₒᵤₜ_{_{—}}ₙ different from what is required by the other electrical loads 20a-20n. For example, each electrical load 20a-20n can require a supply voltage value Vₒᵤₜ_{_{—}}ₐ-Vₒᵤₜ_{_{—}}ₙ comprised between 0.8 V and 3 V, in any case variable according to the application.

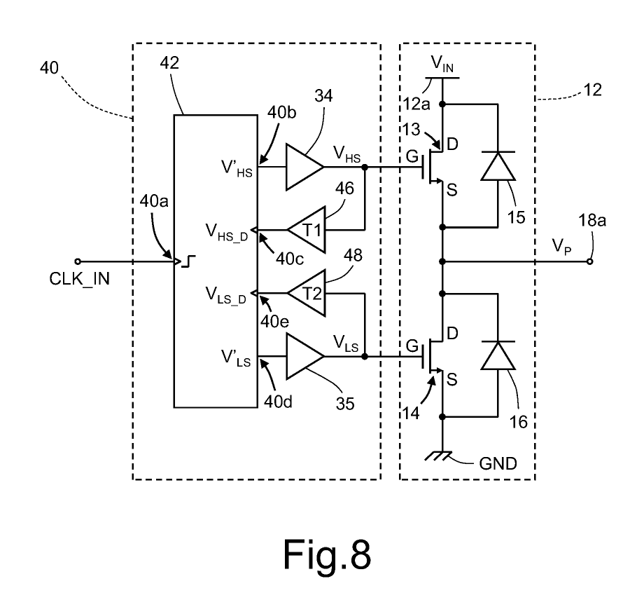

In use, the energy required by the electrical loads 20a-20n for their operation is supplied by the inductor 18, which, in turn, is charged and discharged by controlling appropriately the high-side switch 13 and low-side switch 14 of the main bridge 12. The high-side switch 13 and low-side switch 14 are controlled (opened/closed) in such a way as to prevent a direct connection between the terminal 12a at supply voltage V_{IN} and the ground reference terminal GND. In greater detail, the high-side switch 13 and low-side switch 14 are controlled using a hysteretic voltage control loop, illustrated in FIG. 8.

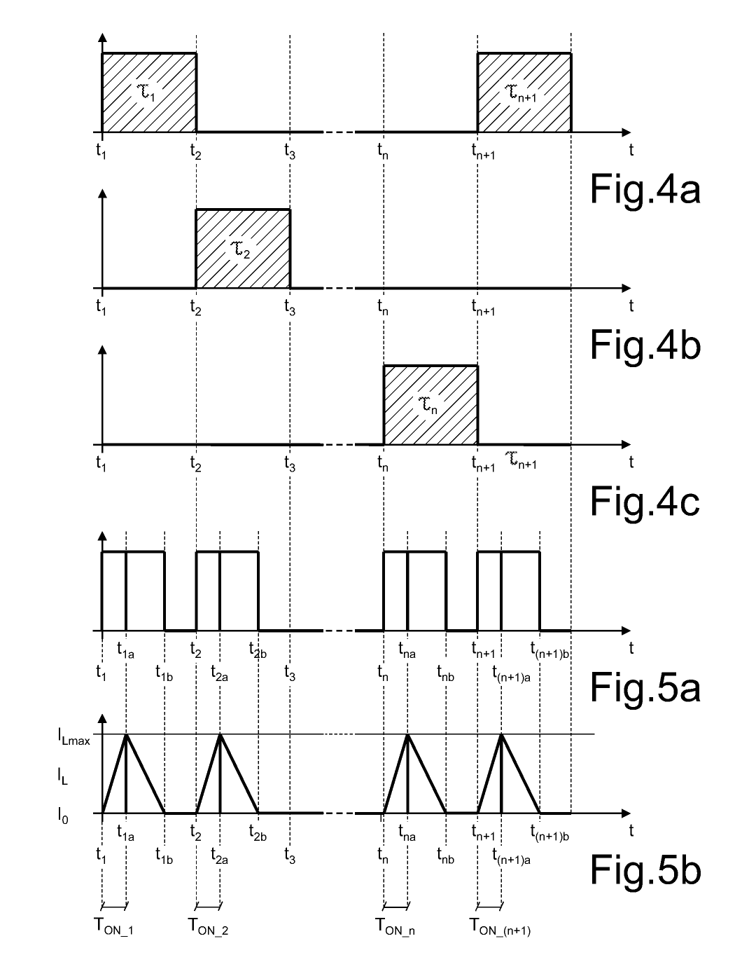

FIGS. 4a-4c show, using one and the same time scale (axis of the abscissae), a plurality of “n” time intervals τ₁-τₙ during which the coupling switches 22a-22n are open or closed so as to implement the time-multiplexing control technique.

FIGS. 5a and 5b show, using the same time scale as that of FIGS. 4a-4c, a method for controlling the high-side switch 13 and the low-side switch 14 in order to charge and discharge the inductor 18 completely in each time interval τ₁-τₙ (according to a discontinuous-conduction mode—DCM—or, alternatively, a pseudo-continuous conduction mode—PCCM).

With reference to FIGS. 4a-4c and 5a, 5b, considering the instant in time t₁ as starting instant, the time interval τ₁ is comprised between t₁ and t₂. During the time interval τ₁, the coupling switch 22a is closed (FIG. 4a), and the remaining coupling switches 22b-22n are open (FIGS. 4b, 4c). Direct connection to one another of two or more electrical loads 20a-20n is thus prevented, consequently preventing phenomena of cross conduction between the electrical loads 20a-20n.

As regards control of the main bridge 12 (FIG. 5a), during the time interval τ₁, in particular between t₁ and t₁ₐ, the high-side switch 13 is closed whilst the low-side switch 14 is open; between t₁ₐ and t_{1b} the high-side switch 13 is open and the low-side switch 14 is closed. Direct connection of the supply terminal 12a to the reference voltage GND is thus prevented, consequently preventing phenomena of cross conduction between the terminal 12a and the reference terminal GND. As illustrated in FIG. 5b, during the interval t₁-t₁ₐ the charging current I_{L} of the inductor 18 increases from the initial value I₀ (inductor discharged) up to the peak value I_{Lmax}, charging the inductor 18. During the interval t₁ₐ-t_{1b}, the inductor 18 is completely discharged, until it reaches again the initial value I₀.

Likewise, considering the time interval τ₂ (comprised between t₂ and t₃), the coupling switch 22b is closed (FIG. 4b), and the remaining coupling switches 22a-22n are open (FIGS. 4a, 4c), preventing cross conduction between the electrical loads 20a-20n.

As regards the main bridge 12 (FIG. 5a), during the time interval τ₂ the high-side switch 13 and the low-side switch 14 are controlled in the same way as has been described with reference to the time interval τ₁. Hence, between t₂ and t₂ₐ the high-side switch 13 is closed and the low-side switch 14 is open; instead, between t₂ₐ and t_{2b}, the high-side switch 13 is open and the low-side switch 14 is closed. Likewise, during the interval t₂-t₂ₐ the charging current I_{L} of the inductor 18 increases from the initial value I₀ (assumed at the end of the time interval τ₁) up to the peak value I_{Lmax}. During the interval t₂ₐ-t_{2b}, the inductor 18 is completely discharged, until it reaches again the initial value I₀.

The process continues for all the “n” switches (i.e., up to the coupling switch 22n) in a similar way, and then restarts in an iterative way.

In conclusion, between t₁ and t₍ₙ₊₁₎, all the electrical loads 20a-20n are supplied in a respective time interval or time slot, preventing phenomena of cross conduction between the electrical loads 20a-20n themselves.

As has been said and as is illustrated in FIG. 5b, in each time interval τ₁-τₙ (and subsequent time intervals τ₍ₙ₊₁₎, etc.) the inductor 18 is charged and discharged completely. In detail, the inductor 18 is charged by closing the high-side switch 13, thus coupling the terminal 18a of the inductor 18 to the terminal 12a of the main bridge 12. Discharge of the inductor 18 is obtained by opening the high-side switch 13 and by closing the low-side switch 14. The terminal 18a of the inductor 18 is in this way coupled to the reference terminal GND, and can hence discharge. The steps of charging and complete discharging of the inductor 18 guarantee the absence of a cross regulation between the various electrical loads 20a-20n.

It is evident that the cross regulation can in any case be minimized even if the inductor 18 does not discharge completely, but the current I_{L} reaches a value close to the starting value I₀. A discharge step that is other than accurate enough can, however, cause in time phenomena of divergence of the current stored in the inductor 18, which increases in an undesirable way. It is hence expedient, in any case, to envisage cycles of complete discharge of the inductor 18.

The step of discharge of the inductor 18 must be appropriately monitored in order to prevent the voltage V_{L} on the inductor 18 from assuming a negative value, causing an absorption of current by the electrical loads 20a-20n when these are coupled to the inductor 18.

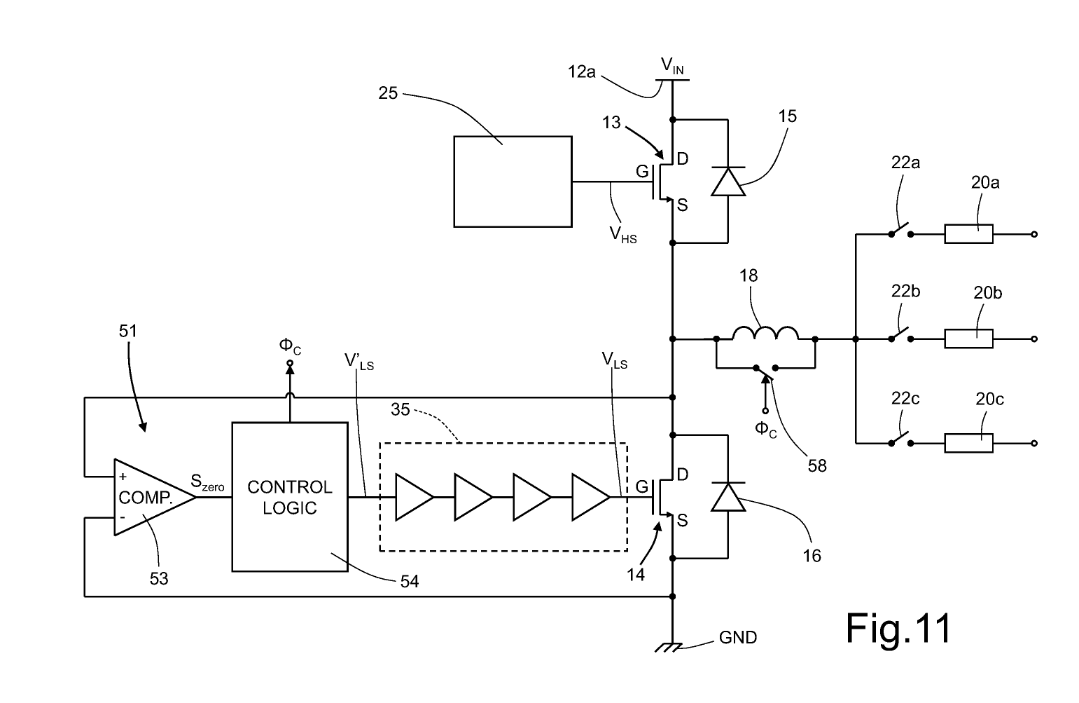

FIG. 11, described hereinafter, shows an embodiment of a circuit designed to monitor the current that flows from the inductor 18 to the reference terminal GND in order to prevent phenomena of discharge of the load 20a-20n.

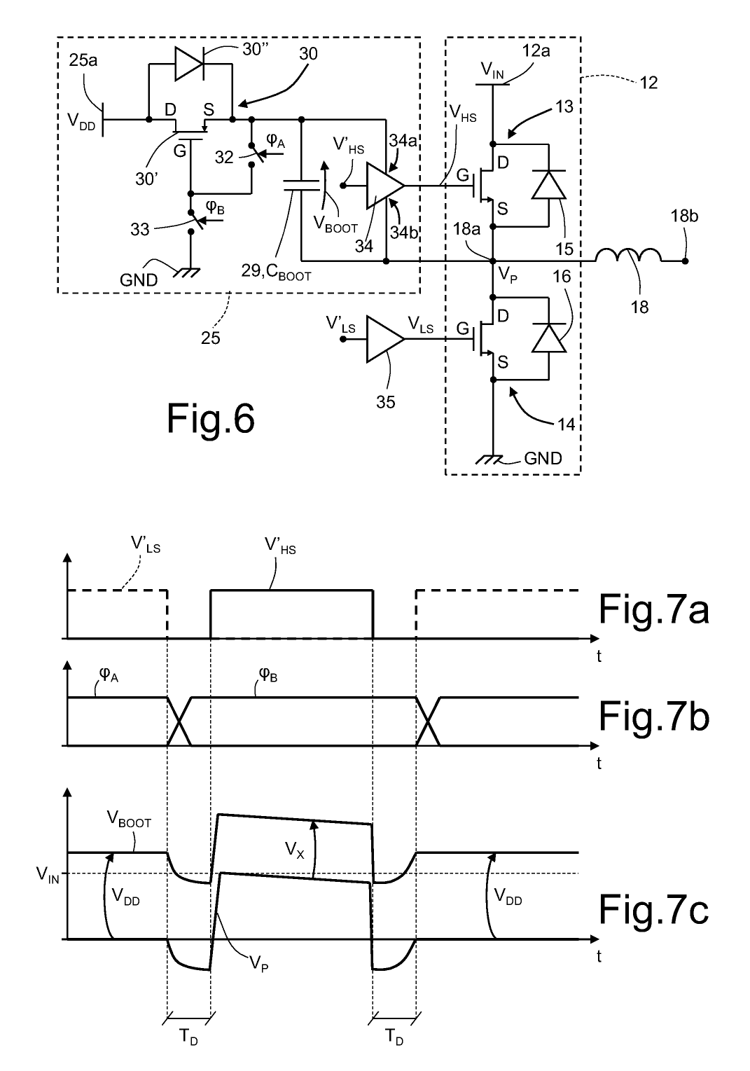

FIG. 6 shows the first and second driving circuits 25, 26 connected to the main bridge 12, according to one embodiment of the present invention.

With reference to the high-side switch 13, the first driving circuit 25 coupled thereto is configured for driving the high-side switch 13 alternately into an open state, in which the high-side switch 13 does not conduct current, and into a closed state, in which the high-side switch 13 conducts current. With reference to a high-side switch 13 of an n-channel MOSFET type (as illustrated in FIG. 6), the first driving circuit 25 is configured for biasing appropriately the gate terminal G of the high-side switch 13 in such a way that, when it is necessary to close the high-side switch 13, the voltage between the source terminal S and the gate terminal G is higher than the turning-on threshold voltage of the high-side switch 13. For this purpose, the first driving circuit 25 comprises a bootstrap circuit. In detail, the first driving circuit 25 comprises: a supply terminal 25a, at a voltage V_{DD} of between approximately 2 V and approximately 3.3 V, for example approximately 2.5 V; a recharging switch 30 (in particular, illustrated in FIG. 6 is a MOSFET 30′, of a p type, with an integrated diode 30″ having the drain terminal D connected to the supply terminal 25a); and a capacitor 29, having capacitance C_{BOOT} of between approximately 200 pF and approximately 700 pF, for example approximately 400 pF, connected between the source terminal S of the recharging switch 30 and the terminal 18a of the inductor 18. The recharging switch 30 is configured for coupling the capacitor 29 to the supply terminal 25a for charging the capacitor 29 by means of the voltage V_{DD}, and, alternately, uncoupling the capacitor 29 from the supply terminal 25a. The first driving circuit 25 moreover comprises further switches 32 and 33. The switch 32 is connected between the source terminal S and the gate terminal G of the recharging switch 30, whilst the switch 33 is connected between the gate terminal G of the recharging switch 30 and the reference terminal GND.

The switches 32 and 33 are, for example, MOSFETs controlled in conduction and inhibition by a respective control signal φ_{A} and φ_{B}, applied to the gate terminal of the respective switch 32, 33. The control signals φ_{A} and φ_{B} are generated by a logic external to the first driving circuit 25 so as to implement the steps described with reference to FIGS. 4a-4c and 5a, 5b.

The high-side switch 13 and the low-side switch 14 have the gate terminal G connected to a respective driving device 34, 35. For example, the first and second driving devices 34, 35 are formed, each, by a chain of “m” inverters, where “m” is an even number.

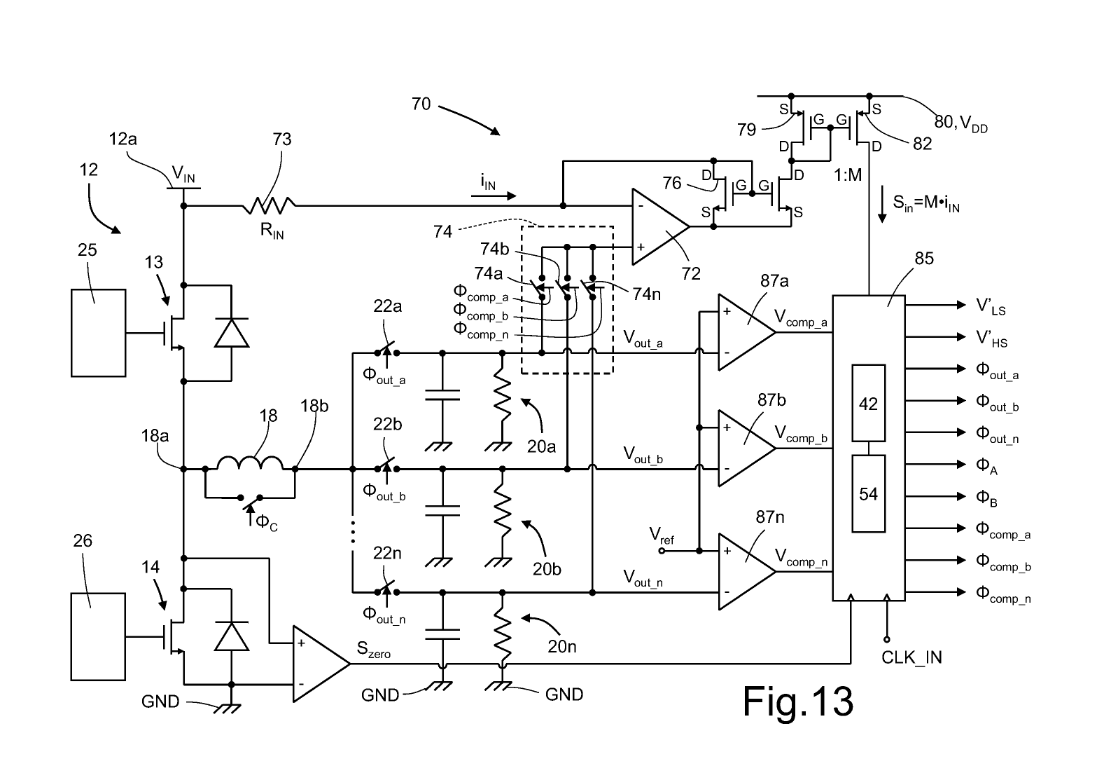

With reference to the driving device 34, the latter comprises a first supply input 34a and a second supply input 34b connected to a floating supply, floating between V_{P} and V_{BOOT}, for generating at output a signal V_{HS} designed to drive (open/close) the high-side transistor 13, on the basis of a signal V_{HS}′ that it receives at input, generated by an appropriate control logic (control logic 42 and control logic 85, described more fully hereinafter with reference to FIGS. 8 and 13). Since the driving device 34 is supplied at a voltage of between V_{P} and V_{BOOT}, in use it is able to generate a voltage for driving the gate terminal of the high-side switch 13 higher than the voltage Vₚ applied to the source terminal S (in particular higher than the turning-on threshold voltage of the high-side switch 13). See, for example, the voltage Vₓ in FIG. 7c.

With reference to the driving device 35, the latter receives at input a signal V_{LS}′ (which is also generated by the control logic), and generates at output a signal V_{LS} designed to drive (open/close) the low-side transistor 14. Since the low-side transistor 14 has its source terminal S connected to the reference GND, a supply circuit similar to the one described with reference to the driving device 34 that will guarantee voltages on the gate terminal G that are variable as a function of the voltage assumed by the source terminal S is not necessary.

FIG. 7a shows, as a function of time t (axis of the abscissae), the plot of the signals V_{HS}′ and V_{LS}′ applied, respectively, to the driving device 34 and 35; FIG. 7b shows, using the same time scale as that of FIG. 7a, the plot of the control signals φ_{A} and φ_{B}, designed to control in opening and closing the switches 32 and 33 of FIG. 6; and FIG. 7c shows, using the same time scale as that of FIGS. 7a and 7b, the plot of the voltage signal V_{BOOT} and of the voltage signal V.

When the low-side switch 14 is closed (signal V_{LS}′ high), the terminal 18a is connected to the ground reference voltage GND, and the signal V_{P} is hence at reference voltage GND (e.g., approximately 0 V). During this time interval the capacitor 29 is charged by means of the voltage V_{DD}. This is made possible by connecting the capacitor 29 to the supply terminal 25a by closing the switch 30 (the switch 33 is closed, and the switch 32 is open). As has already been said, during the time interval in which the low-side switch 14 is closed, the inductor 18 is connected to ground GND and discharges.

When it is necessary to recharge the inductor 18, the switch 30 opens (thus opening the switch 33 and closing the switch 32). Before closing of the high-side switch 13, the low-side switch 14 is opened to prevent phenomena of cross conduction, as has been mentioned previously. The capacitor 29, previously charged, keeps the charge stored and supplies the driving device 34, which, in turn, biases the control terminal of the high-side switch 13, driving it into conduction. The supply terminal 12a is then connected to the terminal 18a of the inductor 18, enabling supply of the electrical load as explained previously.

From FIGS. 7a and 7b, it may be noted that the signal V_{LS}′ is at a high value when the control signal φ_{A} is at a high value (switch 32 open) and the signal V_{HS}′ is at a low value. During this interval, the capacitor 29 is recharged. When the signal V_{LS}′ drops, also the control signal φ_{A} drops (thus closing the switch 32). At the same time, the control signal φ_{B} rises (thus opening the switch 33). After a certain time interval also the signal V_{HS}′ rises. Between the falling edge of the signal V_{LS}′ and the rising edge of the signal V_{HS}′ there is in fact envisaged a guard range T_{D} (dead time) to prevent phenomena of cross conduction.

With closing of the high-side switch 13 the voltage V_{P} rises to the value V_{IN}.

In this step, in which the switch 33 is open and the switch 32 is closed, the capacitor 29 is charged (V_{BOOT}≈V_{DD}). With turning-on of the high-side switch 13, the node at voltage V_{P} increases and, as a result of the (capacitive) bootstrap effect, also the voltage on the opposite plate of the capacitor 29 rises (bootstrap capacitor). The voltage V_{BOOT} across the capacitor 29 is keep substantially constant (but for minor losses, see Eq. (6) given hereinafter). In this way, during the step of turning-on of the high-side switch 13, the driving device 34 is supplied and is hence able to turn on the high-side switch 13.

The voltage drop V_{BOOT}=V_{X} across the capacitor 29 when the high-side switch 13 is closed is given by

$${V}_{X} = {V}_{DD} ( 1 - \frac{{C}_{BOOT}}{{C}_{BOOT} + {C}_{GS}} ) \qquad ( 6 )$$

where C_{GS} is the capacitance between the gate terminal and the source terminal of the high-side transistor 13.

The embodiment of FIG. 6 enables minimization of the area required for the ensemble formed by the high-side switch 13 and the first driving circuit 25, maintaining good characteristics of performance as regards the resistance in the ON state (R_{ON}) and enabling a complete integration of the first driving circuit 25 and of the high-side switch 13 without the need to use external components.

FIG. 8 is a schematic illustration of a dead-time control circuit 40 according to one embodiment of the present invention, coupled to the main bridge 12 of the DC-DC converter 10. The dead-time control logic 40 is configured for generating the signals V_{HS}′ and V_{LS}′, previously described.

The dead-time control circuit 40 comprises a control logic 42, configured for generating, on the basis of a clock signal CLK_IN, which receives on a first input (input 40a), the signals V_{HS}′ and V_{LS}′. The signals V_{HS}′ and V_{LS}′, as has been said, are supplied to the driving devices 34, 35, which generate at output a respective signal V_{HS} and V_{LS} designed to drive the high-side switch 13 and low-side switch 14.

The dead-time control circuit 40 further comprises a first delay element 46 connected between the output of the driving device 34 and a second input 40c of the control logic 42, and configured for receiving at input the signal V_{HS}, delaying it by a time D1, and supplying to the control logic 42 a signal V_{HS}_{_{—}}_{D} temporally delayed by D1 with respect to the signal V_{HS}.

The dead-time control circuit 40 further comprises a second delay element 48 connected between the output of the driving device 35 and a third input 40e of the control logic 42, and configured for receiving at input the signal V_{LS}, delaying it by a time D2, and supplying to the control logic 42 a signal V_{LS}_{_{—}}_{D} temporally delayed by D2 with respect to the signal V_{LS}.

The first and second delay elements 46, 48 comprise, for example, a chain of inverters, or of other elements designed to generate the desired delay D1 and D2. For example, the delays D1 and D2 are comprised between 5 ns and 20 ns, for example, approximately 10 ns.

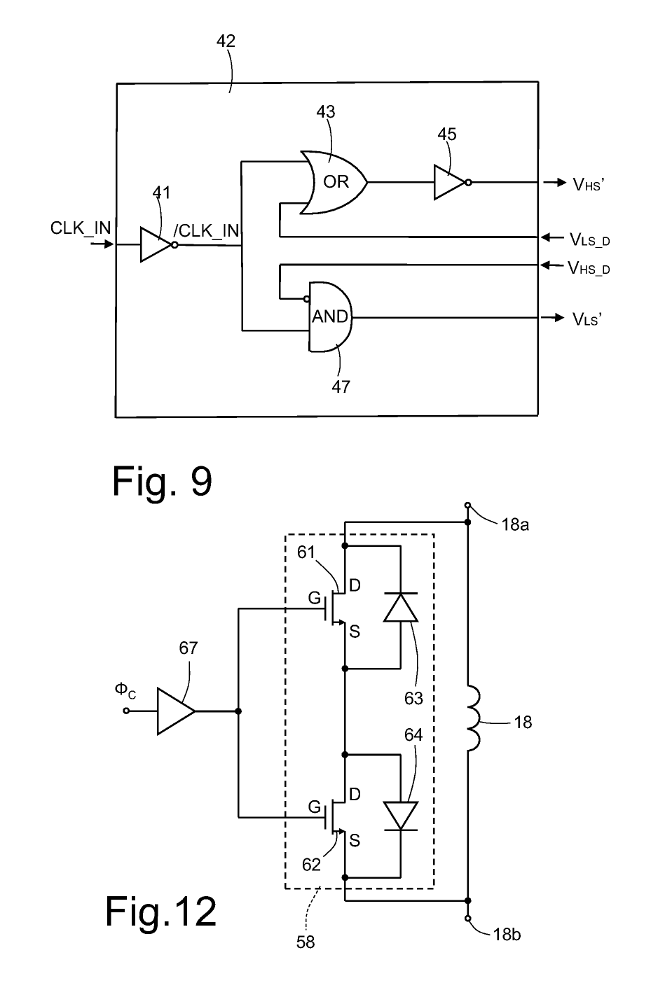

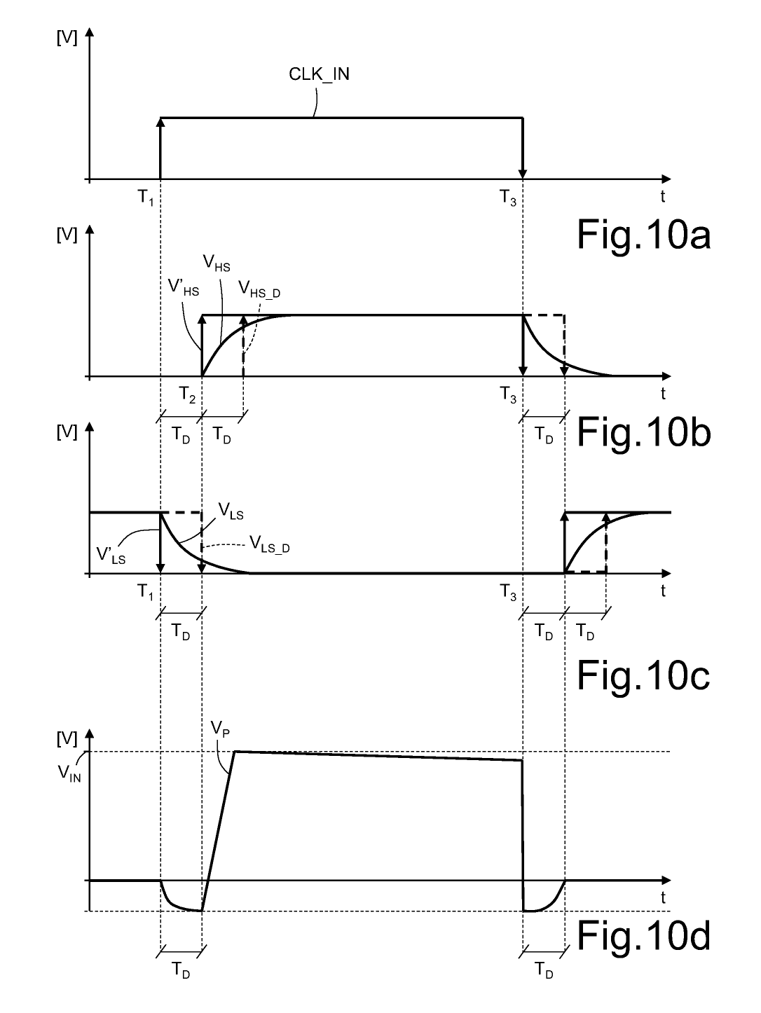

Operation of the control logic 42, for generation of the dead times T_{D}, may be better understood with reference to FIG. 9, which shows in greater detail the control logic 42, and to FIGS. 10a-10d, which are graphic illustrations of the plots of the clock signal CLK_IN (FIG. 10a), of the signals V_{HS}′, V_{HS}, and V_{HS}_{_{—}}_{D} (FIG. 10b), of the signals V_{LS}′, V_{LS}, and V_{LS}_{_{—}}_{D} (FIG. 10c), with reference to the voltage signal V_{P} on the terminal 18a of the inductor 18 (FIG. 10d).

The control logic 42 comprises: an inverter 41, which is connected to the input 40a for receiving the clock signal CLK_IN and generates at output a negated clock signal /CLK_IN; an OR logic gate 43, configured for receiving at input the negated clock signal /CLK_IN and the delayed signal V_{LS}_{_{—}}_{D}; an inverter 45, connected to the output of the OR logic gate 43, and generating the signal V_{HS}′; and an AND logic gate 47, configured for receiving at input the negated clock signal /CLK_IN and the delayed signal V_{HS}_{_{—}}_{D} and generating at output the signal V_{LS}′.

With reference to FIGS. 10a and 10c, at a time T1 the clock signal CLK_IN passes from the low value to the high value. The rising edge of the clock signal CLK_IN indicates the start of the operating steps of the DC-DC converter 10, with control of opening of the low-side switch 14 (in the case where the latter is already open, it is kept open). In the sequel of the operations of the DC-DC converter 10, the steps of opening of the low-side switch 14 are not synchronous with subsequent rising edges of the clock signal CLK_IN, but are forced by the control logic 54 (FIG. 11) on the basis of a signal S_{zero} generated by the comparator 53 (see also in this case FIG. 11).

To return to FIGS. 10a-10d, at the rising edge of the clock signal CLK_IN, the control logic 42 controls the low-side switch 14 in opening, governing a change of state of the signal V_{LS}′, which passes from the high value to the low value (or is kept at a low value in the case where the initial state is the low state). Consequently, the driving device 35 generates the signal V_{LS}. After the interval T_{D} (dead time), in particular T_{D}=D2, the control logic 42 receives at input the signal V_{LS}_{_{—}}_{D}. This fact brings about (time T2) the change of state of the signal V_{HS}′, which passes from the low value to the high value. Consequently, the driving device 34 generates the signal V_{HS} for controlling the high-side switch 13 in closing. On account of the delay with which the signal V_{HS} is brought at input to the control logic 42, the latter receives the signal V_{HS}_{_{—}}_{D} after a delay T_{D}=T1. However, this information can be rejected.

At time T3, the clock signal CLK_IN changes state, passing from the high state to the low state. This brings about a corresponding change of state of the signal V_{HS}′. Consequently, the driving device 34 controls the high-side switch 13 in opening (the signal V_{HS} drops to the low value). The control logic 42 comes to know the change of state of the signal V_{HS} (or, likewise, of the signal V_{HS}′) after a certain delay, at time T3+T_{D}. At this instant, the signal V_{LS}′ is again controlled in such a way as to turn on the low-side switch 14, and the process resumes. As may be noted, at each half-period of the clock signal CLK_IN there is a switching of the high-side switch 13 and low-side switch 14, always guaranteeing the presence of a dead time T_{D} to prevent cross conduction between the high-voltage terminal (terminal 12a) and the reference terminal GND.

During the half-period of the clock signal CLK_IN in which the high-side switch 13 is closed and the low-side switch 14 is open (i.e., between T2 and T3), the voltage V_{P} increases, and the inductor 18 is charged. Instead, in the subsequent half-period, when the low-side switch 14 is closed, the inductor 18 is completely discharged. In order to discharge the inductor 18, it is necessary to apply thereto a voltage of a value opposite to the charging voltage. It is possible to do this in a passive way by exploiting the body diode integrated in a MOSFET, or in an active way using the same transistor as switch. In particular, according to one embodiment of the present invention, the low-side switch 14 is exploited.

In order to discharge the inductor 18 in an active way, the low-side switch 14 is driven appropriately, as described in what follows with reference to FIG. 11.

When the peak limit value of current I_{Lmax} is reached (see, for example, FIG. 5b), after the dead time T_{D}, managed as described with reference to FIGS. 8 and 10a-10d, the low-side switch 14 is closed, thus connecting the terminal 18a to the ground reference terminal GND, hence enabling the inductor 18 to discharge. When the current that flows in the branch of the low-side switch 14 reaches a lower limit value (for example approximately 0 A), the low-side switch 14 is opens, thus interrupting the connection between the terminal 18a and the ground reference terminal GND.

This guarantees that the current in the inductor 18 does not become negative, which could cause a discharge of the electrical loads 20a-20n, with consequent decrease in the global efficiency. The current that flows in the branch of the low-side switch 14 is monitored by means of a current detector 51, for example comprising a comparator 53 having its non-inverting and inverting inputs connected to opposite conduction terminals of the low-side switch 14 (in particular, the non-inverting input connected to the drain terminal D and the inverting input connected to the source terminal S, or, likewise, the non-inverting input connected to the terminal 18a of the inductor 18 and the inverting input connected to the ground reference terminal GND). A control logic 54 receives the signal S_{zero} generated at output by the comparator 53 and, on the basis of the signal S_{zero} thus received, controls the low-side switch 14 in opening or closing, via the driving device 35 (here represented schematically, by way of example, as a chain of inverters).

The DC-DC converter according to the present invention further comprises an anti-oscillation switch 58, connected in parallel to the inductor 18, as illustrated in FIG. 11. The anti-oscillation switch 58 is controlled in opening/closing by the control logic 54, via the signal Φ_{C}. In particular, when the current detected by the current detector 51 reaches the lower-limit value, the control logic 54 governs the low-side switch 14 in opening and the anti-oscillation switch 58 in closing. In this way, any spurious phase oscillations at the terminal 18a, caused by residual energy stored in the inductor 18 and in the parasitic capacitor associated to the terminals 18a and 18b, are prevented. In fact, any possible undesirable oscillations can cause problems of an electromagnetic nature, and consequent reduction of the global efficiency of the DC-DC converter.

FIG. 12 shows in greater detail an embodiment of the anti-oscillation switch 58. The anti-oscillation switch 58 comprises two transistors 61, 62, for example MOSFETs of an n type, connected in “back-to-back” configuration, between the terminal 18a and the terminal 18b of the inductor 18. Illustrated in antiparallel connection with each transistor 61, 62 is a respective diode 63, 64 (diode integrated in the respective transistor 61, 62).

In greater detail, the transistor 61 comprises a drain terminal D connected to the terminal 18a of the inductor 18, the transistor 62 comprises a drain terminal D connected to the terminal 18b of the inductor 18, whilst the source terminals S of the transistor 61 and of the transistor 62 are connected to one another. The control terminals G of the transistors 61 and 62 are, for example, coupled to a driving device 67, designed to receive at input the signal Φ_{C} and control the transistors 61 and 62 in opening/closing, on the basis of the signal Φ_{C}. The driving device 67 comprises, for example, a plurality of inverters cascaded to one another.

In use, when it is necessary to discharge the residual energy of the inductor 18, the anti-oscillation switch 58 is closed, thus driving in conduction both of the transistors 61 and 62. At the end of the step of discharge of the inductor 18, if one of the electrical loads 20a-20n must be recharged, the anti-oscillation switch 58 is opened, thus driving in inhibition both of the transistors 61 and 62 before closing the high-side switch 13.

As described previously, sharing of a single inductor between a plurality of electrical loads 20a-20n is made possible by the presence of the coupling switches 22a-22n, each of which is coupled to a respective electrical load 20a-20n and is configured for supplying the corresponding electrical load 20a-20n according to a time-multiplexing methodology and in a discontinuous mode DCM (for each electrical load 20a-20n, the inductor 18 is charged and discharged completely to a zero current value). The coupling switches 22a-22n are controlled by means of appropriate signals, in respective non-overlapping time intervals (see FIGS. 4a-4c). Each electrical load 20a-20n is supplied, if necessary, in a respective time slot τ₁-τₙ. A voltage hysteretic comparator verifies whether the respective electrical load 20a-20n needs to be supplied, and, if so, generates the respective supply time slot τ₁-τₙ and closes the respective coupling switch 22a-22n.

When an electrical load 20a-20n needs to be supplied (e.g., the output voltage of the DC-DC comparator 10 for that particular electrical load 20a-20n is lower than a given threshold), the main bridge 12 is controlled as described previously in order to charge the inductor 18. Hence, the respective coupling switch 22a-22n is closed, thus connecting the inductor 18 to the respective electrical load 20a-20n. Since control of the coupling switches 22a-22n is carried out in time-multiplexing, these steps are carried out in each time slot τ₁-τₙ envisaged for supplying the respective electrical load 20a-20n.

However, the operation of charge and discharge of the inductor 18, in order to supply the electrical load 20a-20n, is carried out only if the corresponding electrical load 20a-20n needs to be supplied. Otherwise, no operation is carried out until one of the outputs needs to be recharged; only if this condition is verified are the time slots generated. In this way, the energy consumption is minimized, enabling high values of efficiency to be achieved.

FIG. 13 shows the DC-DC converter 10 according to the present invention comprising an adaptive-control circuit 70 configured for managing closing and opening of the high-side switch 13 and low-side switch 14 of the main bridge 12.

The adaptive-control circuit 70 comprises an amplifier 72, having an inverting input coupled, by means of a resistor 73 (with resistance R_{IN} of between approximately 5 MΩ and 20 MΩ; for example R_{IN} is approximately 10 MΩ), to the supply terminal 12a of the main bridge 12, for receiving the supply signal V_{IN}, and a non-inverting input that can be coupled, alternatively, to one of the lines for supply of the electrical loads 20a-20n, to pick up the output signal Vₒᵤₜ_{_{—}}ₐ, Vₒᵤₜ_{_{—}}_{b}, . . . , Vₒᵤₜ_{_{—}}ₙ supplied to the respective electrical load 20a-20n. For this purpose, the adaptive-control circuit 70 comprises a multiplexer device 74, including a plurality of “n” switches 74a-74n, each of which is connected between the non-inverting input of the comparator 72 and a respective line for supply of the loads 20a-20n. The multiplexer device 74 operates in such a way that the non-inverting input of the amplifier 72 is connected, each time, to only one of the output signals Vₒᵤₜ_{_{—}}ₐ, Vₒᵤₜ_{_{—}}_{b}, . . . , Vₒᵤₜ_{_{—}}ₙ, according to the time slot in which it is operating (for example, in the time slot τ1 it receives the signal Vₒᵤₜ_{_{—}}ₐ, in the time slot τ₂ it receives the signal Vₒᵤₜ_{_{—}}_{b}, etc.).

The output of the amplifier 72 is connected in feedback mode to the inverting input via a transistor 76, for example a MOSFET of an n type. The source terminal S of the transistor 76 is connected to the output of the comparator 72, whereas the drain terminal D and gate terminal G are both connected to the non-inverting input of the amplifier 72. In this way, the transistor 76 is traversed in conduction by a current proportional to the supply signal V_{IN}. Moreover connected to the output of the amplifier 72 is a transistor 78, for example a MOSFET of an n type. The transistor 78 comprises a source terminal S connected to the output of the amplifier 72, a gate terminal G connected to the gate terminal G of the transistor 76 (and hence to the inverting input of the amplifier 72), and a drain terminal D. In particular, the drain terminal D of the transistor 76 is connected to a supply terminal 80 at voltage V_{DD} via a transistor 79. The transistor 79 comprises a source terminal S connected to the supply terminal 80, and a drain terminal D and a gate terminal G connected to one another. A further transistor 82 is connected in current-mirror configuration to the transistor 79. In particular, the transistor 82 comprises a gate terminal connected to the gate terminal of the transistor 79, a source terminal connected to the supply terminal 80, and a drain terminal, connected to a control logic 85. The control logic 85 includes, according to the embodiment illustrated, the control logic 42 described with reference to FIG. 8 and the control logic 54 described with reference to FIG. 11.

The adaptive-control circuit 70 converts the input voltage V_{IN} into a current signal i_{IN} proportional to the voltage V_{L} on the inductor 18 and enables control of the peak current of the inductor 18, preventing it from increasing excessively. In particular, the circuit 70 has the task of generating a current signal Sᵢₙ=M·i_{IN} (where 1:M is the gain ratio of the current mirror formed by the transistors 79 and 82) that is proportional to the voltage V_{L} present on the inductor 18.

The current signal Sᵢₙ is given by

Sᵢₙ=(V_{IN}−Vₒᵤₜ_{_{—}}ₓ)·M/R_{IN} (7)

where Vₒᵤₜ_{_{—}}ₓ assumes the values Vₒᵤₜ_{_{—}}ₐ, or Vₒᵤₜ_{_{—}}_{b}, . . . , or Vₒᵤₜ_{_{—}}ₙ, according to the time slot considered.

The current signal Sᵢₙ thus generated is used by the control logic 85 for generating a control signal, of duration T_{ON}, designed to keep the high-side switch 13 in the ON state (i.e., in conduction). In this way, the peak current I_{Lmax} that flows through the inductor 18 remains constant irrespective of the input voltage V_{IN}.

The time interval T_{ON} during which the inductor 18 is charged assumes a variable value according to the input voltage value V_{IN} or, rather, according to the value assumed by the current signal i_{IN}, which is proportional to the value of voltage drop V_{L} on the inductor 18.

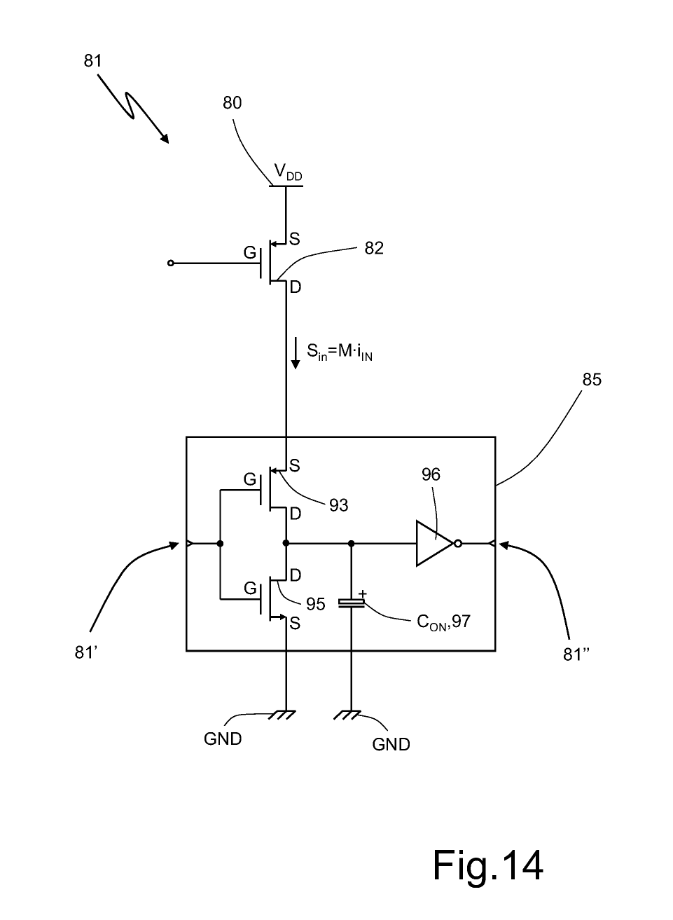

In greater detail, the control logic 85 receives at input, via the transistor 82, the signal Sᵢₙ proportional to the current i_{IN} that flows through the resistor 73 (and in the branch comprising the transistors 78 and 79). The signal Sᵢₙ is received by a time-delay generation circuit 81, illustrated in FIG. 14, integrated in the control logic 85. The time-delay generation circuit 81 comprises a transistor 93, a MOSFET of a p type, having the source terminal connected to the drain terminal of the transistor 82, with a transistor 95 in series, a MOSFET of an n type, having the source terminal connected to the reference terminal GND. The gate terminals of the transistors 93 and 95 form an input port 81′ of the time-delay generation circuit 81.

The drain terminals of both of the transistors 93 and 95 are connected to one another and to an inverter 96. Moreover connected between the drain terminal of the transistors 93 and 95 and the reference terminal GND is a capacitor 97, having a capacitance C_{ON} of between 100 fF and 1 pF, for example, 500 fF.

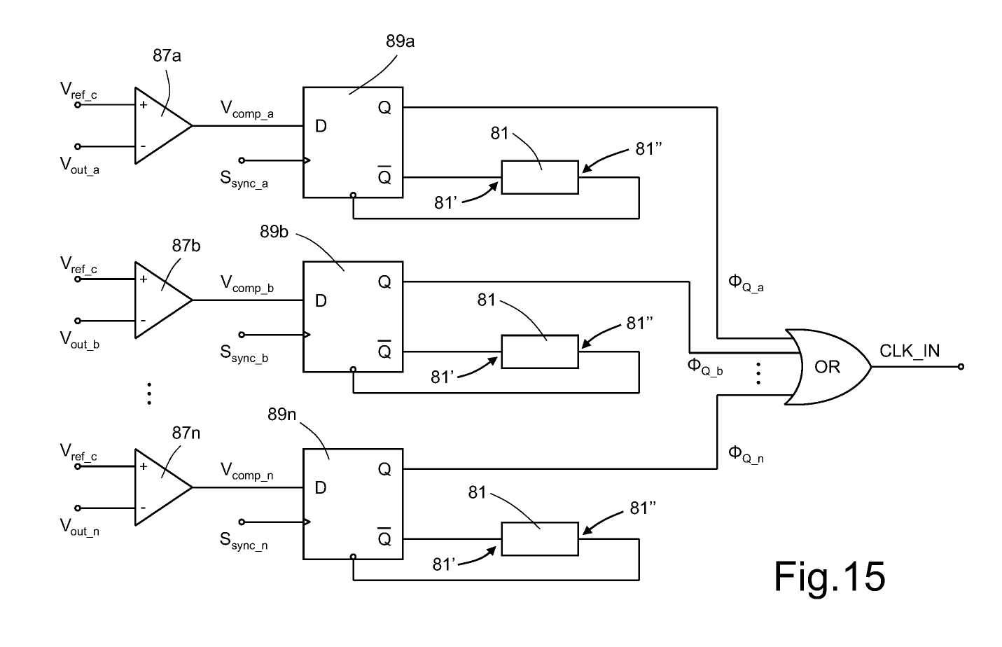

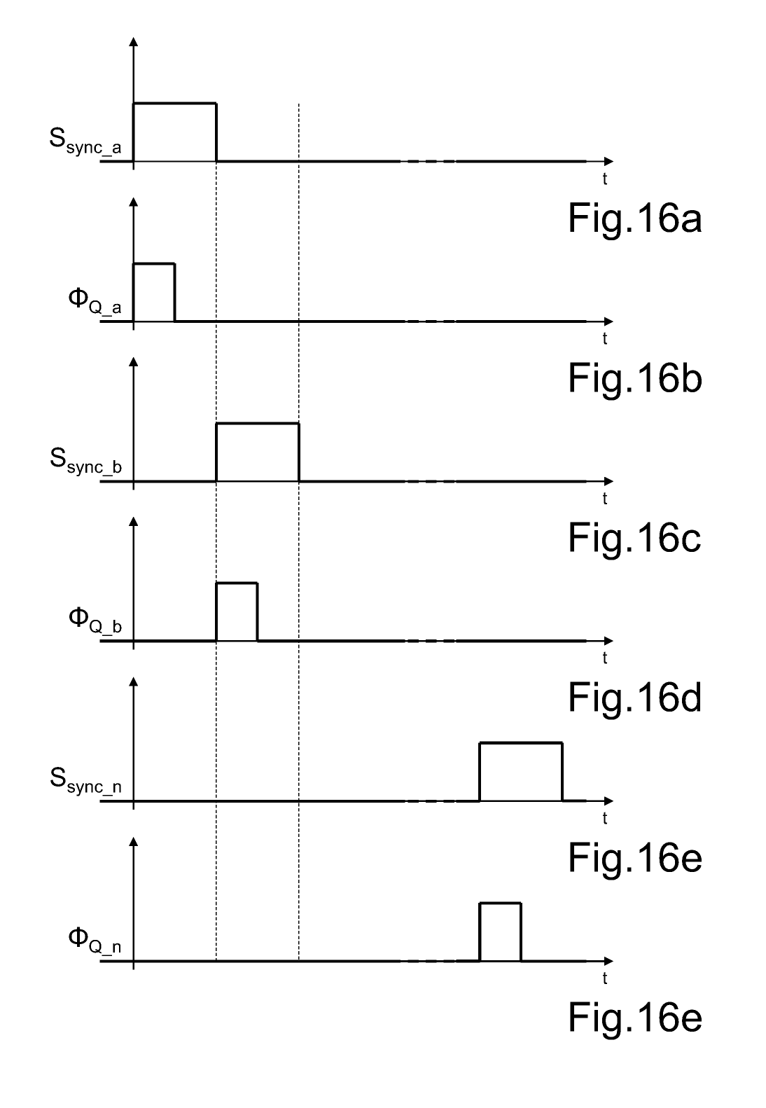

As illustrated in FIG. 15, the hysteretic comparators 87a-87n (already illustrated in FIG. 13) are connected each to a respective flip-flop 89a-89n of a D type, in such a way that the output of each hysteretic comparator 87a-87n is supplied at input to the respective flip-flop 89a-89n. Each flip-flop 89a-89n moreover includes a synchronization input, for receiving a respective synchronization signal S_{sync}_{_{—}}ₐ-S_{sync}_{_{—}}ₙ (clock signals, schematically illustrated in FIGS. 16a, 16c, 16e).

The output /Q of each flip-flop 89a-89n is fed back by means of the time-delay generation circuit 81 of FIG. 14. The output Q of each flip-flop 89a-89n supplies, instead, a respective signal Φ_{Q}_{_{—}}ₐ-Φ_{Q}_{_{—}}ₙ (illustrated in FIGS. 16b, 16d, 16f), each defining a rectangular-window time signal that defines the duration T_{ON}. In this way each flip-flop 89a-89n is able to generate a pulse of duration T_{ON} compensated as a function of the value of V_{IN} it is to be recalled herein that the time-delay generation circuit 81 receives at input the signal Sᵢₙ). The signals Φ_{Q}_{_{—}}ₐ-Φ_{Q}_{_{—}}ₙ are supplied at input to an OR logic, which generates at output the clock signal CLK_IN, used, as illustrated previously, for driving the main bridge 12.

In conclusion, the time-delay generation circuit 81 of FIG. 14 receives at input a digital signal generated by the flip-flop 89a-89n to which it is connected and produces a pulse of duration T_{ON} proportional to the current signal Sᵢₙ, exploiting the capacitor 97 and the inverter 96. Since the current Sᵢₙ is proportional to the voltage V_{L} on the inductor 18 thanks to the adaptive-control circuit 70, the time T_{ON} is inversely proportional to the voltage V_{L} (as highlighted by Eq. (9)). This enables generation of a peak current I_{Lmax} in the inductor 18 of a constant value as the input voltage V_{IN} varies.

The following Eq. (8) shows the time interval T_{ON} during which the high-side switch 13 is closed and the inductor 18 is charged (with reference to FIG. 5b, the time intervals t₁-t₁ₐ, t₂-t₂ₐ, tₙ-tₙₐ, etc.), as a function of the current i_{IN} that charges the capacitor 97:

$$\{ \begin{matrix}{T}_{ON} = {C}_{ON} \frac{{V}_{th\_inv}}{{S}_{IN}} = {C}_{ON} \frac{{V}_{DD}}{2} \frac{1}{{S}_{IN}} \\ {S}_{IN} = M \frac{{V}_{IN} - {V}_{out\_x}}{{R}_{IN}} = M \frac{{V}_{L}}{{R}_{IN}}\end{matrix} \qquad ( 8 )$$

wherein Vₒᵤₜ_{_{—}}ₓ is the output voltage on the electrical load 20a-20n considered, and chosen in the group comprising the output voltages Vₒᵤₜ_{_{—}}ₐ, Vₒᵤₜ_{_{—}}_{b}, . . . , Vₒᵤₜ_{_{—}}ₙ; Vₜₕ_{_{—}}ᵢₙᵥ is the threshold voltage of the inverter 96 of FIG. 14; and C_{ON} is the value of capacitance of the capacitor 97 of FIG. 14.

From Eq. (8) we find that T_{ON} is given by:

$${T}_{ON} = {C}_{ON} \frac{{V}_{DD}}{2} \frac{R}{{MV}_{L}} \qquad ( 9 )$$

i.e., T_{ON} is proportional to 1/V_{L}.

As regards the peak current I_{Lmax} that flows in the inductor 18, we have that said current is given, approximately, by the following Eq. (10):

$${I}_{L ma x} = \frac{{V}_{L}}{L} {T}_{ON} = \frac{{V}_{L}}{L} {C}_{ON} \frac{{V}_{DD}}{{MV}_{L}} = \frac{{RC}_{ON} {V}_{DD}}{2 ML} \qquad ( 10 )$$

whence we find that the peak current I_{Lmax} does not depend directly upon the value of the input supply voltage V_{IN}.

The control logic 85 carries out generation of the signals for turning-on/turning-off the high-side switch 13 and the low-side switch 14, but also generation of the control signals of the switches of the multiplexer device 74 and of the anti-oscillation switch 58. For this purpose, the control logic 42 receives at input, in addition to the clock signal CLK_IN and to the current signal Sᵢₙ, also a plurality of “n” signals indicating the output voltages Vₒᵤₜ_{_{—}}ₐ-Vₒᵤₜ_{_{—}}ₙ of each electrical load 20a-20n. For this purpose, coupled to each load 20a-20n, is a respective hysteretic comparator 87a-87n (in which each hysteretic comparator, of a type in itself known, comprises a first threshold Vₜₕ⁻ and a second threshold Vₜₕ⁺, with Vₜₕ⁻<Vₜₕ⁺. Each hysteretic comparator 87a-87n comprises an inverting input configured for receiving one of the output signals Vₒᵤₜ_{_{—}}ₐ-Vₒᵤₜ_{_{—}}ₙ, and a non-inverting input configured for receiving a reference signal V_{ref}_{_{—}}_{c}.

The reference signal V_{ref}_{_{—}}_{c} is a bandgap reference, independent of the supply voltage and of the temperature. In FIG. 13, the comparators 87a-87n all receive one and the same reference signal V_{ref}_{_{—}}_{c}.

However, it is possible to generate a reference signal. In actual fact, each comparator will receive a reference V_{ref}_{_{—}}_{c} that is different for each comparator 87a-87n, on the basis of the values of the output voltages Vₒᵤₜ_{_{—}}ₐ-Vₒᵤₜ_{_{—}}ₙ. The hysteretic control loop causes each output to be regulated to the value V_{ref} set.

The output of each hysteretic comparator 87a-87n indicates the level of voltage assumed by each output signal Vₒᵤₜ_{_{—}}ₐ-Vₒᵤₜ_{_{—}}ₙ. The signal V_{comp}_{_{—}}ₐ, V_{comp}_{_{—}}_{b}, . . . , V_{comp}_{_{—}}ₙ generated at output by each hysteretic comparator 87a-87n is received at input by the control logic 85 and processed thereby to be used during the steps of supply of the electrical loads 20a-20n. The latter, in fact, are supplied (recharged) only when the respective output voltage signal Vₒᵤₜ_{_{—}}ₐ, Vₒᵤₜ_{_{—}}_{b}, . . . , Vₒᵤₜ_{_{—}}_{n drops below the threshold defined by the reference signal V}_{ref}_{_{—}}_{c}.

Each hysteretic comparator 87a-87n has two possible output logic levels, in particular the ground reference value (GND, or equivalent) or the value of the supply signal (V_{DD}). When the n-th signal V_{comp}_{_{—}}ₙ at output from the n-th hysteretic comparator 87n is equal to V_{DD}, then the respective output voltage Vₒᵤₜ_{_{—}}ₙ has dropped below the reference V_{ref}_{_{—}}_{c} and the respective electrical load 20n must be recharged. When the n-th signal V_{comp}_{_{—}}ₙ at output from the n-th hysteretic comparator 87n is equal to GND, then the respective output voltage Vₒᵤₜ_{_{—}}ₙ is higher than the reference V_{ref}_{_{—}}_{c} and the respective electrical load 20n does not have to be recharged. The characteristic of the n-th comparator 87n is centered around the reference V_{ref}_{_{—}}_{c} and is the classic hysteretic characteristic (indicatively with thresholds Vₜₕ⁺>V_{ref}_{_{—}}_{c} and Vₜₕ⁻<V_{ref}_{_{—}}_{c}).

In order to decide whether each electrical load 20a-20n needs to be recharged, each hysteretic comparator 87a-n monitors continuously, as has been said, the output signals Vₒᵤₜ_{_{—}}ₐ-Vₒᵤₜ_{_{—}}ₙ. If one of the output signals Vₒᵤₜ_{_{—}}ₐ-Vₒᵤₜ_{_{—}}ₙ drops below the threshold Vₜₕ⁻ of the respective hysteretic comparator 87a-87n, the main bridge is driven as described previously, and the respective electrical load 20a-20n is supplied and charged. This occurs, as has been said, in the time slot τ₁-τₙ envisaged for supplying that particular electrical load 20a-20n. The charging step terminates when the output signal Vₒᵤₜ_{_{—}}ₐ-Vₒᵤₜ_{_{—}}ₙ exceeds the threshold Vₜₕ⁺ (and in any case within the reserved time slot). With this type of control, the output “ripples” depend exclusively upon the hysteresis of the comparators 87a-87n, whilst the frequency of the charging step is a function of the capacitance of the output capacitor and of the current of the load. In this context, the load current is the current that flows in the load resistance connected in parallel to the output capacitance, as represented in FIG. 13 for each electrical load 20a-20n. The lower the load resistance, the higher the load current, and consequently, the greater the need to recharge the electrical load and the higher the frequency of the ripple.

Each comparator 87a-87 is configured to have the hysteresis equal to the maximum value of ripple tolerated by the specific application, for example approximately 10-50 mV.

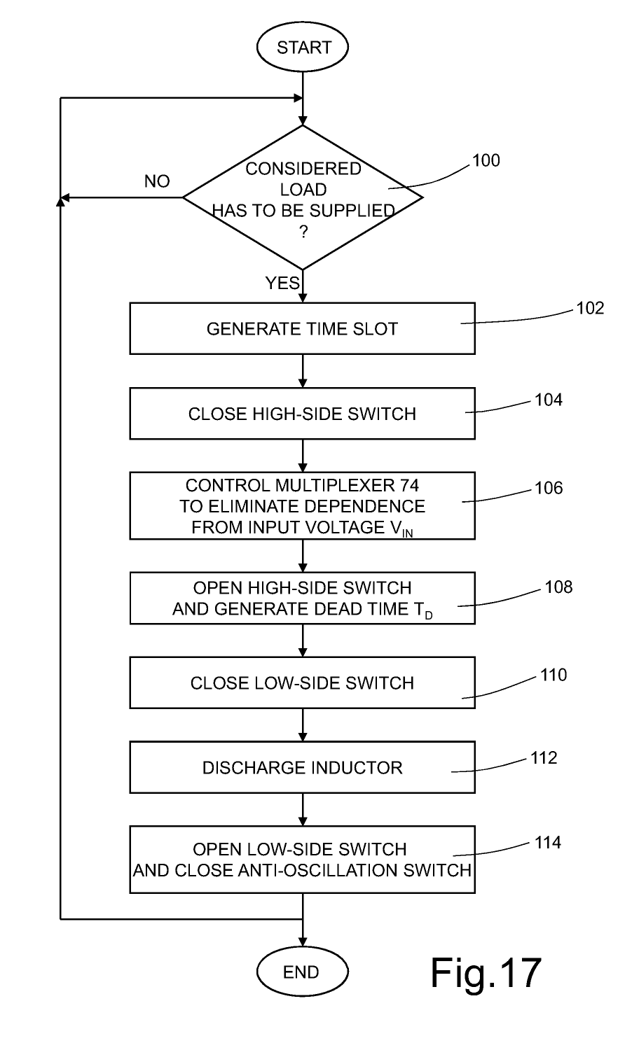

FIG. 17 illustrates, schematically and by means of a block diagram, the steps performed by the control logic 85 in each time slot τ₁-τₙ, i.e., for each electrical load 20a-20n to be supplied. In the case where the corresponding electrical load 20a-20n does not need to be supplied, the steps of FIG. 17 are not carried out (or rather, just step 110 is carried out where it is verified whether an electrical load 20a-20n needs to be supplied).

First of all, the control logic 85 verifies (step 100) whether a first electrical load (hereinafter the electrical load 20a is considered) needs to be supplied, on the basis of the value assumed by the signal V_{comp}_{_{—}}ₐ generated by the hysteretic comparator 87a (see also what has been said with reference to FIG. 13). If not (i.e., if the electrical load 20a does not need to be supplied), flow returns to a mode of observation of the outputs until at least one output needs to be charged. Otherwise, if the electrical load 20a is to be supplied, the time slot τ1 is generated (step 102), the corresponding switch for supply of the load is closed, and control passes to step 104.

In step 104, the control logic 85 closes the high-side switch 13. For this purpose, at a first rising edge of the clock signal CLK_IN, the control logic 85 generates the signals φ_{A} and φ_{B}, for closing the switch 33 and opening the switch 32 (see also FIG. 6). The signals φ_{A} and φ_{B} generated by the control logic 85 are, for example, supplied at input to a respective driving circuit (not illustrated, for example an amplifier or a cascade of inverters), connected to the switches 32 and 33, and configured for controlling the switches 32, 33 in opening/closing using voltage signals having an appropriate amplitude variable as a function of the specific implementation of the switches 32, 33 (for example, in the case of switches 32, 33 of a MOSFET type, the voltage signals generated by the driving devices as a function of the signals φ_{A} and φ_{B} are such as to drive the respective MOSFET into conduction by generating a gate-source voltage higher than the threshold voltage of the respective MOSFET).

As described previously, following upon generation of the signals φ_{A} and φ_{B} the signal V_{HS}′ that enables closing of the high-side switch 13 is asserted. As soon as the high-side switch 13 conducts, the voltage at the terminal 18a starts to rise, locking to V_{IN}. At the same time, owing to the capacitive effect, given that the difference of potential across the capacitor 29 remains unvaried, the voltage V_{BOOT} rises, thus enabling the driving device 34 to generate a signal V_{HS} such as to keep the high-side switch 13 in conduction.

The inductor 18 can hence be charged.

The control logic 85 moreover generates a signal Φₒᵤₜ_{_{—}}ₐ for driving (JD the coupling switch 22a (the time slot τ1 is now considered). The signal Φₒᵤₜ_{_{—}}ₐ (possibly supplied to the coupling switch 22a via an appropriate driving device similar to the one already described) drives the coupling switch 22a in conduction, thus connecting the inductor 18 to the load 20a.

Next (step 106), the control logic 85 generates the signal φ_{comp}_{_{—}}ₐ for closing the switch 74a of the multiplexer device 74. The control logic 85 hence receives at input the signal Sᵢₙ and calculates, according to Eq. (3) given above, the time interval T_{ON} for charging the inductor 18 completely.

At the end of T_{ON} (step 108), the high-side switch 13 opens (the control logic 85 generates an appropriate signal V_{HS}′ such that, via the driving device 34, the high-side switch 13 is driven into the open state) and the dead time T_{D} is generated as described with reference to FIG. 8.

The signal V_{HS}′ is a CMOS logic signal, of amplitude equal to V_{DD}. The duration at the high value of the clock signal CLK_IN is equal to T_{ON}. Hence, the high-side switch 13 opens instantaneously as CLK_IN drops to the low level. Instead, the low-side switch 14 closes with a certain delay given by the value of the dead time T_{D}. During the dead time T_{D} the current of the inductor 18 circulates in the parasitic diode 16 of the low-side switch 14 and the terminal 18a, at voltage V_{P}, drops to values lower than the reference GND (approximately −0.7V).

Then, the control logic 85 drives the low-side switch 14 into the closed state by generating the signal V_{LS}′, which is applied, via the driving device 35, to the control terminal of the low-side switch 14. The signal V_{LS}′, like V_{HS}′, is a CMOS logic signal of amplitude V_{DD}.

The inductor 18 is then discharged (step 112). During the step 112 of discharge of the inductor 18 the discharge current that flows through the low-side switch 14 is monitored by means of the current detector 51, in particular by means of the comparator 53 (see also FIG. 11 and the corresponding description). The control logic 85 receives the signal S_{zero} generated by the comparator 53 and, when it detects that the discharge current of the inductor 18 has reached a zero value (for example by means of comparison with a reference value stored), drives (step 114) the low-side switch 14 into the open state (thus generating the signal V_{LS}′) and drives the anti-oscillation switch 58 into the closed state, thus generating the signal Φ_{C} (as described previously). Before passing to the possible subsequent time slot the coupling switch 22a is re-opened.

Then, the next electrical load 20b can be supplied, by generating a new time slot τ₂ (as has been said, only if necessary).

The procedure is repeated for all the loads and, after supply of the n-th electrical load 20n, it can starts off again with supply of the electrical load 20a.

The frequency of the clock signal CLK_IN is, for example, defined on the basis of a clock signal CLK generated outside the DC-DC converter circuit 10, or generated by a clock circuit of an integrated type. The clock frequency CLK is, for example, between approximately 100 kHz and approximately 400 kHz, for example approximately 230 kHz.

The signal CLK_IN has a frequency equal to CLK. The clock signal CLK can be generated by means of an oscillator circuit of a known type. On each rising edge of the clock signal the time slot is generated, of a duration equal to the period of oscillation of the clock signal. When no output needs to be recharged the clock is set in “sleep” mode, i.e., in low-consumption mode, and no time slot is generated. As soon as an output needs to be charged, the finite-state machine is woken up again and starts again from where it had stopped with generation of the time slots.

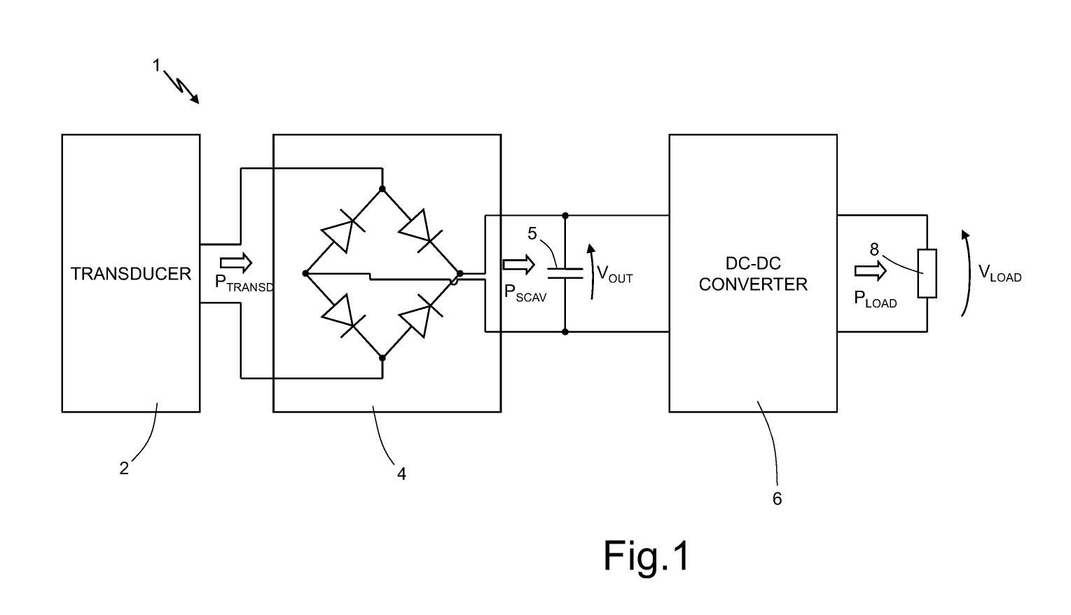

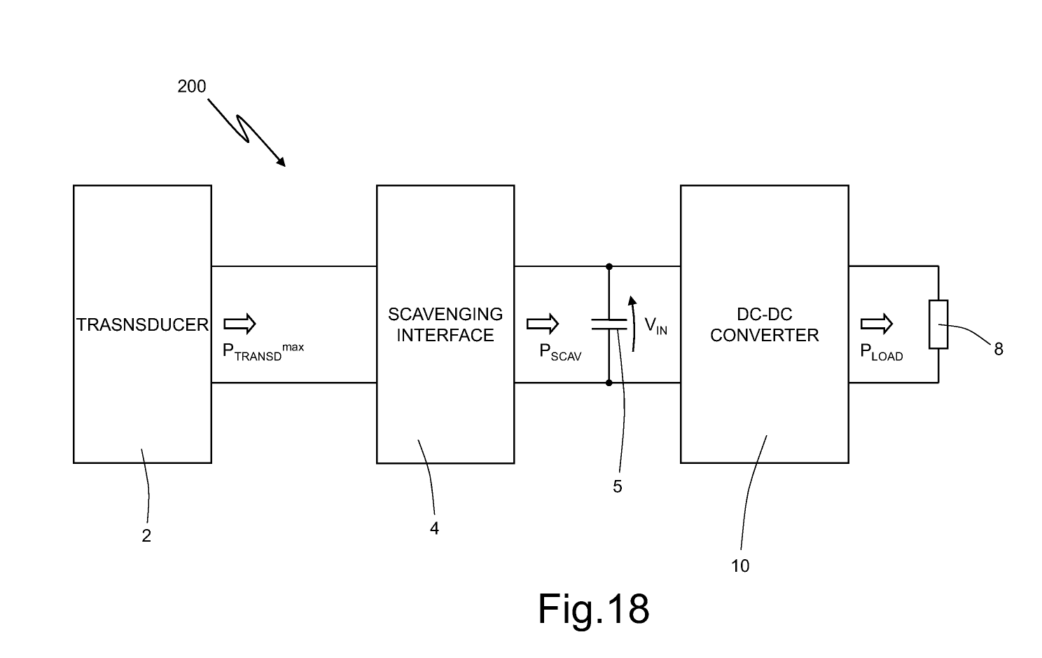

FIG. 18 shows an energy harvesting system 200 comprising the DC-DC converter 10 according to the present invention. The energy harvesting system 200 is similar to the energy harvesting system 1 of FIG. 1 (elements in common are designated by the same reference numbers), and is not described further herein.

The transducers 2 can be all of the same type or of a type different from one another, indifferently. For example, the transducer/transducers 2 can be chosen in the group comprising: electrochemical transducers (designed to convert chemical energy into an electrical signal), electromechanical transducers (designed to convert mechanical energy into an electrical signal), electroacoustic transducers (designed to convert variations of pressure into an electrical signal), electromagnetic transducers (designed to convert a magnetic field into an electrical signal), photoelectric transducers (designed to convert light energy into an electrical signal), electrostatic transducers, thermoelectrical transducers.

The DC-DC converter 10 is connected to the output of the scavenging interface 4. The energy stored on the storage capacitor of the scavenging interface 4 (known) supplies the DC-DC converter. The input voltage of the DC-DC converter is hence the voltage produced by the scavenging interface 4.

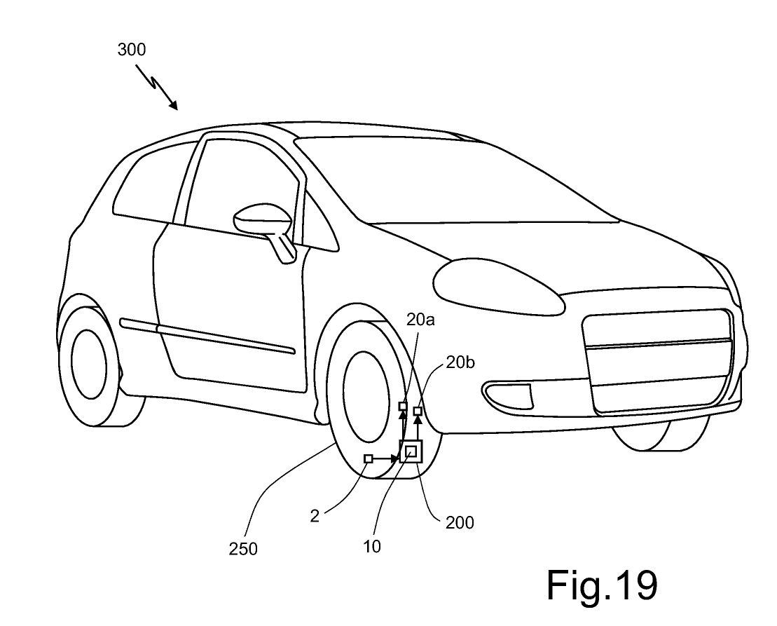

FIG. 19 shows a vehicle 300 comprising the energy harvesting system 200 of FIG. 18, according to one embodiment of the present invention. The vehicle 300 is, in particular, a motor vehicle. It is evident, however, that the energy harvesting system 200 can be used in any vehicle 300 or in systems or apparatuses other than a vehicle.

In particular, the energy harvesting system 200 can find application in generic systems in which it is desirable to harvest, store, and use environmental energy, in particular by means of conversion of mechanical energy into electrical energy.

With reference to FIG. 19, the vehicle 300 comprises one or more transducers 2 coupled in a known way to a portion of the vehicle 300 subjected to mechanical stresses and/or vibrations, for converting said mechanical stresses and/or vibrations into electric current.

The energy harvesting system 200 is connected to one or more electrical loads 20a, . . . , 20n, via interposition of the DC-DC converter 10, as described. In particular, according to an application of the present invention, the electrical loads 20a, . . . , 20n comprise, for example, TPM (“tire parameters monitoring”) sensors for monitoring parameters of tires 250 of the vehicle 300. In this case, the TPM sensors are coupled to an internal portion of the tires 250 of the vehicle 300. Likewise, also the transducers 2 (for example, of an electromagnetic, or piezoelectric type) are coupled to an internal portion of the tires 250. The stress on the transducers 2 when the vehicle 300 is travelling causes production of a current/voltage electrical signal at output from the transducer 2 by means of conversion of the mechanical energy into electrical energy. The electrical energy thus produced is stored, as previously described, in the storage element 5 and supplied, via the DC-DC converter 10, to the TPM sensors.

According to one embodiment of the present invention, the energy harvesting system 200 and the TPM sensors are glued inside one or more tires 250. The impact of the tire 250 on the ground during motion of the vehicle 300 enables production of electrical energy.

As an alternative to what is illustrated in FIG. 19, the energy harvesting system 200 can be set in any other portion of the vehicle 300, and/or used for supplying an electrical load 20a-20n other than or additional to the TPM sensors.

Another possible application of the energy harvesting system 200 is the generation of electrical energy by exploiting the mechanical energy produced by an individual when he is walking or running. In this case, the energy harvesting system 200 is located inside the shoes of said individual (for example, inside the sole). In systems aimed at fitness, where it is particularly interesting to count the steps, it is useful to recover energy from the vibrations induced by walking/running to be able to supply, without using a battery, acceleration sensors and/or RFID transmitters capable of communicating with cellphones, music-playing devices, or any other apparatus involved in information on the steps performed.

From an examination of the characteristics of the invention obtained according to the present disclosure the advantages that it affords are evident.

In particular, the DC-DC converter 10 according to the present invention enables supply of a plurality of loads 20a-20n that require low supply voltages with high efficiency, using a single inductor 18 and overcoming problems of cross regulation between the loads 20a-20n.

Moreover, the DC-DC converter 10 can be completely integrated in an energy harvesting system 200, which must typically guarantee high performance and strength in regard to stresses. The high integratability is afforded by the presence of the bootstrap network 25 for turning on the high-side switch 13 of a type internal to (integrated in) the DC-DC converter 10.

In addition, the dead-time generation circuit 40 guarantees generation of an optimal dead time T_{D} for different input voltages V_{IN}.

Finally, the adaptive-control circuit 70 enables operation of the DC-DC converter 10 in constant-peak-current mode over a wide range of input voltages, enabling compensation of the time interval T_{ON} for different values of the input voltage V_{IN}.

Finally, it is clear that modifications and variations may be made to what has been described and illustrated herein without thereby departing from the sphere of protection of the present invention, as defined in the annexed claims.

In particular, the control technique described is regardless of the circuit architecture of the DC-DC converter.

It can be applied to any DC-DC converter of a SIMO type, of a voltage-boosting type, of a “buck-boost” type, etc.

What is claimed is:

1. A DC-DC converter, comprising:
a charge switch and a discharge switch connected in series to one another between a source node of electrical energy and a reference node;
an inductor having a first conduction terminal and a second conduction terminal, the first conduction terminal of the inductor being connected between the charge switch and the discharge switch;
a plurality of coupling switches, each of which connected between the second conduction terminal of the inductor and a respective electrical load node configured to supply an output supply signal; and
an adaptive-control circuit configured to acquire, for each electrical load node, a signal indicative of a voltage value stored between the first and second conduction terminals of the inductor, and generate, for each electrical load node, a first time interval as a function of the signal indicating the voltage value detected,
wherein, during the first time interval, the charge switch is configured to connect the first conduction terminal of the inductor to the source node of electrical energy in order to charge the inductor, and wherein, during a second time interval subsequent to the first time interval, the discharge switch is configured to connect the first conduction terminal of the inductor to the reference node in order to discharge the inductor.

2. The converter according to claim 1, wherein the adaptive-control circuit comprises an operational circuit including: a first input terminal coupled to the source node of electrical energy and configured to receive an input supply signal; a second input terminal connectable to the electrical load to be supplied and configured to receive a respective output supply signal; and an output terminal configured to supply an intermediate signal proportional to a difference between the input supply signal and the output supply signal, said first time interval being inversely proportional to said intermediate signal.

3. The converter according to claim 1, further comprising:
a plurality of comparator circuits each configured to receive a respective output supply signal and a respective comparison reference signal, and generate a respective result signal obtained from a comparison of the output supply signal to the comparison reference signal, said result signal being indicative of a need to supply the respective electrical load; and
control logic configured to receive, for each comparator circuit, the result signal and control operation of the coupling switch on the basis of the result signal.

4. The converter according to claim 3, wherein the control logic further comprises a processing circuit configured to define a plurality of consecutive time intervals, each coupling switch being closed during a respective one of those time intervals and open during the remaining time intervals, according to a time-multiplexing control technique.

5. The converter according to claim 1, wherein the inductor is charged during the first time interval and discharged during the second time interval, according to a conduction mode of a discontinuous type, or according to a conduction mode of a pseudo-continuous type.

6. The converter according to claim 1, further comprising:
a comparator coupled to the first conduction terminal of the inductor and configured to receive an electrical signal present at the first conduction terminal, and coupled to the reference node and configured to receive an electrical signal present at the reference node, and configured to generate, on the basis of a comparison between the electrical signal at the first conduction terminal and the electrical signal at the reference node, a zero-current signal; and
a discharge-driving circuit configured to receive the zero-current signal and, on the basis of the zero-current signal, detect, during the second time interval, a zero-current state in which the discharge current that flows from the inductor to the reference node, through the discharge switch, reaches a value close to the zero value, and in response thereto open the discharge switch.

7. The converter according to claim 6, further comprising an anti-oscillation switch connected in parallel to the inductor, wherein the discharge-driving circuit is configured to close the anti-oscillation switch when the discharge current that flows from the inductor to the reference node through the discharge switch reaches said value close to the zero value.

8. The converter according to claim 1, further comprising a circuit configured to generate dead times by generating a third time interval between the first time interval and the second time interval.

9. The converter according to claim 8, wherein the circuit comprises:
a conduction-control logic configured to generate a first charge-control signal adapted to control the charge switch in a first operating state and, alternatively, in a second operating state, and to generate a first discharge-control signal adapted to control the discharge switch in the first operating state when the charge switch is in the second operating state, and vice versa;
a first delay element configured to acquire a second charge-control signal which is a function of the first charge-control signal and delay the second charge-control signal by a value equal to the third time interval so as to generate a delayed charge-control signal;
a second delay element configured to acquire a second discharge-control signal which is a function of the first discharge-control signal and delay the second discharge-control signal by a value equal to the third time interval so as to generate a delayed discharge-control signal,
wherein the conduction-control logic is moreover configured to acquire the delayed charge-control signal and the delayed discharge-control signal, detect a variation from the first operating state to the second operating state of one of the charge switch and the discharge switch, and generate a corresponding variation from the second operating state to the first operating state of the other between the charge switch and the discharge switch.

10. The converter according to claim 1, further comprising a first driving circuit configured to drive the charge switch, the first driving circuit comprising:
a driving device including a plurality of inverters connected in series to one another;
a bootstrap capacitor coupled to a first and a second supply input of the driving device;
a bootstrap switch connected between a supply terminal and the first supply input of the driving device and operable during the first time interval to couple the supply terminal to the bootstrap capacitor, thus charging the bootstrap capacitor and supplying the driving device.

11. An energy-harvesting system, comprising:
a transducer configured to convert energy coming from an energy source which is external to said system into an AC electrical signal;
a rectifier circuit configured to receive the AC electrical signal and supply a DC output signal;
a first storage element coupled to the rectifier circuit and configured to receive the DC output signal and store electrical energy; and
a DC-DC converter configured to receive the DC output signal generated by the rectifier circuit and supply an electrical load signal, wherein the DC-DC converter comprises:
a charge switch and a discharge switch connected in series to one another between a source node of electrical energy and a reference node;
an inductor having a first conduction terminal and a second conduction terminal, the first conduction terminal of the inductor being connected between the charge switch and the discharge switch;
a plurality of coupling switches, each of which connected between the second conduction terminal of the inductor and a respective electrical load node configured to supply an output supply signal; and
an adaptive-control circuit configured to acquire, for each electrical load node, a signal indicative of a voltage value stored between the first and second conduction terminals of the inductor, and generate, for each electrical load node, a first time interval as a function of the signal indicating the voltage value detected,
wherein, during the first time interval, the charge switch is configured to connect the first conduction terminal of the inductor to the source node of electrical energy in order to charge the inductor, and wherein, during a second time interval subsequent to the first time interval, the discharge switch is configured to connect the first conduction terminal of the inductor to the reference node in order to discharge the inductor.

12. The system of claim 11 wherein the transducer is coupled to an apparatus capable of supplying energy.

13. The system according to claim 12, wherein said apparatus is a means of transport or footwear.

14. A method for operating a DC-DC converter, wherein the DC-DC converter comprises:
a charge switch and a discharge switch connected in series to one another between a source of electrical energy and a reference;
an inductor having a first conduction terminal and a second conduction terminal, the first conduction terminal of the inductor being connected between the charge switch and the discharge switch; and
a plurality of coupling switches, each of which connected between the second conduction terminal of the inductor and a respective electrical load output to supply an output supply signal, the method comprising:
acquiring, for each electrical load to be supplied, a signal indicating the voltage value stored between the first and second conduction terminals of the inductor;
generating, for each electrical load to be supplied, a first time interval as a function of the signal indicating the voltage value detected;
during the first time interval controlling the charge switch so as to connect the first conduction terminal of the inductor to the source of electrical energy for charging the inductor; and
during a second time interval subsequent to the first time interval, controlling the discharge switch so as to connect the first conduction terminal of the inductor to the reference for discharging the inductor.

15. The method according to claim 14, further comprising:
for each electrical load to be supplied, comparing a respective output supply signal with a respective comparison reference signal;
generating a respective result signal obtained from the comparison between the output supply signal and the comparison reference signal, said result signal being indicative of the need to supply the respective electrical load; and
controlling operation of the coupling switch on the basis of the result signal.

16. The method according to claim 15, further comprising:
defining a plurality of time intervals subsequent to one another;
in each time interval, verifying whether a respective electrical load needs to be supplied; and, if so,
closing a respective coupling switch and maintaining the remaining coupling switches open.

17. The method according to claim 14, further comprising charging the inductor during the first time interval and discharging the inductor during the second time interval, according to a conduction mode of a discontinuous type or according to a conduction mode of pseudo-continuous type.

18. The converter according to claim 14, further comprising:
acquiring an electrical signal present on the first conduction terminal;
acquiring an electrical signal present on the reference;
comparing the electrical signal present on the first conduction terminal with the electrical signal present on the reference;
generating, on the basis of said comparison, a zero-current signal indicating a zero-current state in which the discharge current that flows from the inductor to the reference, through the discharge switch, assumes a value close to the zero value; and
when the zero-current state is reached, opening the discharge switch.

19. The method according to claim 18, wherein the DC-DC converter further comprises an anti-oscillation switch, connected in parallel to the inductor, the method further comprising closing the anti-oscillation switch when the discharge current that flows from the inductor to the reference, through the discharge switch, reaches said value close to the zero value.

20. The method according to claim 14, further comprising generating a third time interval between the first time interval and the second time interval.

21. The method according to claim 20, comprising:
generating a first charge-control signal, adapted to control the charge switch in a first operating state and, alternatively, in a second operating state;
generating a first discharge-control signal, adapted to control the discharge switch in the first operating state when the charge switch is in the second operating state, and vice versa;
acquiring a second charge-control signal, which is a function of the first charge-control signal;
delaying the second charge-control signal by a value equal to the third time interval to generate a delayed charge-control signal;
acquiring a second discharge-control signal, which is a function of the first discharge-control signal;
delaying the second discharge-control signal by a value equal to the third time interval to generate a delayed discharge-control signal;
acquiring the delayed charge-control signal and the delayed discharge-control signal;
detecting, on the basis of the delayed charge-control signal or of the delayed discharge-control signal, a variation from the first operating state to the second operating state of one between the charge switch and the discharge switch; and
generating a variation from the second operating state to the first operating state of the other between the charge switch and the discharge switch.

22. A DC-DC converter, comprising:
a charge switch coupled between a supply node and a first intermediate node, the charge switch controlled by a charge signal;
a discharge switch coupled between the first intermediate node and a reference node, the discharge switch controlled by a discharge signal;
an inductor coupled between the first intermediate node and a second intermediate node;
a first output switch coupled between the second intermediate node and a first output node;
a second output switch coupled between the second intermediate node and a second output node;
a sensing circuit configured to sense a voltage across the inductor; and
a control circuit configured to sequentially activate the first and second output switches and for each activation convert the sensed voltage to a corresponding first time interval, the control circuit further configured to activate the charge switch for the corresponding first time interval and then activate the discharge switch for a second time interval following the first time interval.

23. The converter according to claim 22, further comprising:
a first comparator configured to compare a first output signal at the first output node to a reference signal; and
a second comparator configured to compare a second output signal at the second output node to a reference signal;
wherein the control circuit controls the sequential activation of the first and second output switches in response to outputs from the first and second comparators.

24. The converter according to claim 23, wherein the sequential activation is implemented by the control circuit using a time-multiplexing control technique.

25. The converter according to claim 22, further comprising:
a third comparator configured to compare an intermediate signal at the first intermediate node to a reference signal to generate a signal indicative of inductor current; and
wherein the control circuit is further configured to detect, during the second time interval and from the signal indicative of inductor current, a zero-current condition and in response thereto deactivate the discharge switch.

26. The converter according to claim 25, further comprising an anti-oscillation switch connected between the first intermediate node and the second intermediate node, wherein the control circuit is further configured to activate the anti-oscillation switch in response to detection of said zero-current condition.
